(19) United States
(12) Patent Application Publication
(10) Pub. No.: US 2007/0146477 A1
(43) Pub. Date: Jun. 28, 2007

(54) CCTV CAMERA SYSTEM AND WIRELESS NON-VIDEO/VIDEO DOOR PHONE SYSTEMS ALL HAVING AC/DC SELF-SUSTAINED POWER SUPPLY APPARATUS

(75) Inventor: Neng-Chia Lee, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: MEMETICS TECHNOLOGY CO., LTD., Taipei (TW)

(21) Appl. No.: 11/616,505

(22) Filed: Dec. 27, 2006

(30) Foreign Application Priority Data
Dec. 27, 2005 (TW) 094146869

(51) Int. Cl. H04N 7/14

(52) U.S. Cl. 348/14.01

(57) ABSTRACT

The provided camera system includes an AC/DC self-sustained power supply apparatus, a camera coupled to the apparatus and receiving a first power supply and a video transmitting device coupled to the camera and transmitting a video signal generated by the camera to a monitor system. Furthermore, a wireless non-video door phone system having at least three DC self-sustained power supply apparatuses and a wireless video door phone system having at least three DC/AC self-sustained power supply apparatuses are also provided.

### FIELD OF THE INVENTION

The present invention relates to the configurations of a CCTV camera system and wireless non-video/video door phone systems each having at least one AC/DC self-sustained power supply apparatus (SPSA). More particularly, the present invention relates to the configurations of the CCTV camera system and the wireless non-video/video door phone systems each having at least one SPSA and receiving an AC/DC power supply via an autogenic energy generating apparatus (AEGA) of the AC/DC SPSA.

### BACKGROUND OF THE INVENTION

Electronic equipment would depend on an external power supply unless a battery is employed. For electronic equipment using a battery, the use time of the electronic equipment would be limited by the battery life time, thus the power status of the battery needs to be checked and a bad/dead battery needs to be changed repeatedly. Right now, the waste batteries are not properly handled and causing the globally environmental pollution concerns. Since the totally recovery and reuse of the waste battery so as to prevent further environmental pollution is not well taken, using the disposable battery is not a good alternative from the environmental protection point of view. Besides, even if the rechargeable battery is employed, still the use time of the electronic equipment is still limited by the battery life time. Each time when the rechargeable battery is used and dead, the battery needs to be recharged by a charger for a relatively longer charging time before it can be reused. Thus, at least two sets of rechargeable batteries needs to be prepared to keep the electronic equipment handy not to mention that changing the battery repeatedly is quite inconvenient. Therefore, using the rechargeable battery is not a good alternative too. On the other hand, the installation location of the electronic equipment, which depends on an external power supply, would be limited by where the external power supply is located. For example, when a CCTV camera system is installed, the location of the AC power supply must be considered (where is the socket located? it is usually either an indoor AC power supply providing a first AC power supply, or a combination of the indoor AC power supply and an adapter receiving the first AC power supply and providing a second DC/AC power supply). However, choosing the best location and angle for the camera to take a clear shoot and offer a proper video image for the CCTV monitoring system must be considered when the CCTV camera system is installed so as to achieve a better effectiveness for the CCTV monitoring system. Thus, the CCTV camera system does have its limits on choosing the proper installation locations. Please refer to FIG. 1, which is the schematic diagram showing the configuration of a conventional CCTV monitoring system having a CCTV camera system. The conventional CCTV monitoring system 1 includes a main unit 11, a monitor (or a video receiving apparatus) 12 and a CCTV camera system 13. In which, the CCTV camera system 13 includes an AC/DC power supply (including a socket) 131, a CCTV camera 132 and a support 133. The AC/DC power supply 131 is one of an AC/DC power supply provided through the voltage rectifying and the voltage boosting/bucking of an adapter (the adapter and the power line are shown in solid lines) and an AC power supply provided via a commercial power source (the plug and the AC power line are shown in dash lines). In FIG. 1, the monitor 12 of the CCTV monitoring system 1 is coupled to the main unit 11 through a first video signal line, and the CCTV camera 132 is coupled to the main unit 11 through a wireless transmission (or through a second video signal line as shown in dash lines). Thus, to solve the conflict regarding where the socket of the power supply is located may not be exactly the same location as where the CCTV camera system shall be located for a better performance of the CCTV camera system, i.e. choosing the best location and angle for the camera to take a clear shoot and offer a proper video image for the CCTV monitoring system, is one of the purposes of the present invention.

Similarly, the installation of the conventional non-video/video door phone systems are time-consuming due to the set-up of the interconnect wiring since the entry panel for the visitors installed at a main entrance of one of an apartment and a building, a plurality of telephone extensions each installed at a different resident home, the electric control lock installed in a main entry door of one of an apartment and a building, an AC/DC power supply and the commercial power source are all electrically connected to each other via connecting wires. When the connecting wires are damaged, it is also time-consuming for the maintenance due to that all the connecting wires are located in the pipelines, which are deployed far apart and deep inside the building, and makes it hard to do the trouble-shooting and the replacement of the damaged connecting wires. The above-mentioned problem could be solved when the wireless transmission apparatus transmitting/receiving radio frequency signals and the self-sustained power supply apparatus providing the AC/DC power supplies are both employed in the non-video/video door phone systems provided in the present invention. A conventional non-video door phone system 2 having a DC power supply, which is provided by the commercial power source via a voltage rectifying and a voltage boosting/bucking, includes an entry panel 21, a plurality of telephone extensions 22 and an electric control lock 23 as shown in FIG. 2(a). In which, the entry panel 21 includes a data input apparatus 211(it could also be a plurality of first switches each having a push-button), each of the plurality of telephone extensions 22 includes a second switch 221 having a push-button, a handset 222 having a telephone transmitter (TT) 2221 and a telephone receiver (TR) 2222 and a base unit 223 having a telephone line 2231 and an open-close switch (not shown) between the handset 222 and the base unit 223, and the electric control lock 23 includes a push-button 231 and a lockset 232. Furthermore, a conventional video door phone system 3 having an AC/DC power supply, which is provided by the commercial power source via a voltage rectifying and a voltage boosting/bucking, includes an entry panel 31, a plurality of telephone extensions 32 and an electric control lock 33 as shown in FIG. 2(b). In which, the entry panel 31 includes a plurality of first switches each having a push-button 311 (it could also be a data input apparatus), each of the plurality of telephone extensions 32 includes a second switch 321 having a push-button, a display screen 322 and a handset 323 having a telephone transmitter (TT) 3231 and a telephone receiver (TR) 3232 and a base unit 324 having a telephone line 3241 and an open-close switch (not shown) between the handset 323 and the base unit 324, and the electric control lock 33 includes a push-button 331 and a lockset 332. Thus, to solve the problems regarding the time-consuming set-up of the interconnect wiring and the trouble-shooting and replacement of the damaged connecting wires during the maintenance for the non-video/video door phone systems having an AC/DC power supply provided by a commercial power source through a voltage rectifying and a voltage boosting/bucking, are also the purposes of the present invention.

Currently, a device generating an autogenic energy continuously, which could be employed in driving a generator so as to generate an AC/DC output voltage, is proposed in U.S. Pat. No. 6,731,035. In the '035 Patent, the provided device is driving a flywheel via the interactions between two permanent magnets to generate a kinetic energy continuously. However, the preferred embodiment and the relative contents of the '035 Patent are focused on expressing how a proposed configuration of the proposed device could be employed to generate the autogenic energy continuously (see FIG. 4) but nothing regarding how to really use it in certain area is mentioned. Please refer to FIG. 4, an autogenic energy generating device 4 includes a base 422, a first magnetic device 450 having a first magnet 451, a second magnetic device 430 having a second magnet 431, a transmission member 420, and a linking device 440. Furthermore, the transmission member 420 includes a horizontal shaft 421 (the second magnet 431 is fixed to a rectangular intermediate portion 4211 of the horizontal shaft 421), the base 422 includes a first support plate 4221 (having a guide slot 4223) and a second support plate 4222, and the linking device 440 includes a linking rod 442, a connection rod 443 and a flywheel 444, which is employed to rotate the transmission member 420 continuously. Though, the '035 Patent provides a simple configuration of the autogenic energy generating device 4 and the operational principles of the autogenic energy generating device 4, but nothing is mentioned regarding how the autogenic energy generating device 4 is employed to drive an AC/DC generator to generate an AC/DC power supply to be used in the related electronic equipment, e.g., the CCTV camera system and the wireless non-video/video door phone systems of the present invention.

Since the DC generator has an extra commutator than the AC generator, thus relatively the DC generator has a more complex configuration and a higher manufacturing cost than those of the AC generator. Therefore, a self-sustained power supply apparatus includes an autogenic energy generating apparatus having the autogenic energy generating device and an AC generator, a rectifier, a regulator, and one of a DC/DC converter and a DC/AC inverter is provided in the present invention. In which, the AC generator receives the kinetic energy generated by the autogenic energy generating device so as to generate an AC output voltage firstly. The AC output voltage is rectified via a rectifier into a DC output voltage secondly. The DC output voltage is regulated by a voltage regulator thirdly. The regulated DC output voltage is input to one of a DC/DC converter and a DC/AC inverter to generate a DC/AC input voltage for the electronic equipment lastly. The DC/DC converter (or the DC/AC inverter) is employed to either boost or convert the regulated DC output voltage into the DC/AC input voltage. Each of the CCTV camera system and the wireless non-video/video door phone systems receives the required DC/AC power supply continuously from the self-sustained power supply apparatus. Also, the self-sustained power supply apparatus includes a switch, which turns off the apparatus when it is necessary to cut off the power supply of the CCTV camera system and the non-video/video door phone systems for the maintenance or saving the energy resources.

Keeping the drawbacks of the prior arts in mind, and employing experiments and research full-heartily and persistently, the CCTV camera system and the wireless non-video/video door phone systems all having the self-sustained power supply apparatus are finally conceived by the applicant.

### SUMMARY OF THE INVENTION

It is therefore an object of the present invention to provide a CCTV camera System to overcome the drawbacks of the prior art such that the installation location of the CCTV camera System is not limited by the location of the external power supply, there is no need of using the disposable and rechargeable batteries, and there is no waste battery generated so as to protect the global environment.

It is therefore another object of the present invention to provide the wireless non-video/video door phone systems to overcome the drawbacks of the prior art such that the time-consuming set-up of the interconnect wiring and the trouble-shooting and replacement of the damaged connecting wires during the maintenance of the conventional non-video/video door phone systems could be avoided totally.

According to the first aspect of the present invention, a CCTV camera system having a self-sustained power supply apparatus for a video monitoring system having a main unit includes a camera receiving a first power supply from the apparatus and generating a video signal and a video transmission apparatus transmitting the video signal to the main unit.

Preferably, the first power supply is one of a first AC power supply and a first DC power supply, and the self-sustained power supply apparatus includes an autogenic energy generating apparatus generating a second AC power supply, a switch determining one of a turn-on and a turn-off states of the generating apparatus, a rectifier rectifying the second AC power supply into a second DC power supply, a regulator regulating the second DC power supply and generating a third DC power supply, a DC/DC converter receiving the third DC power supply and generating the first DC power supply through one of a step-up and a step-down, in which the DC/DC converter is one selected from a group consisting of a boost converter, a buck-boost converter and a flyback converter when the DC/DC converter is going through the step-up, and the DC/DC converter is one selected from a group consisting of a buck converter, a buck-boost converter, a forward converter, a flyback converter, a half-bridge converter and a full-bridge converter when the DC/DC converter is going through the step-down and a DC/AC inverter receiving the third DC power supply and generating the first AC power supply.

Preferably, the first power supply is one of a first AC power supply and a first DC power supply, and the self-sustained power supply apparatus includes an autogenic energy generating apparatus generating a second AC power supply, a switch determining one of a turn-on and a turn-off states of the generating apparatus, a rectifier rectifying the second AC power supply into a second DC power supply, a regulator regulating the second DC power supply and generating a third DC power supply, a DC/DC converter receiving the third DC power supply and generating the first DC power supply through one of a step-up and a step-down and a DC/AC inverter receiving the first DC power supply and generating the first AC power supply.

Preferably, the first power supply is a first DC power supply, and the self-sustained power supply apparatus includes an autogenic energy generating apparatus generating an AC power supply, a switch determining one of a turn-on and a turn-off states of the generating apparatus, a rectifier rectifying the AC power supply into a second DC power supply, a regulator regulating the second DC power supply and generating a third DC power supply and a DC/DC converter receiving the third DC power supply and generating the first DC power supply through one of a step-up and a step-down.

Preferably, the video transmission apparatus is one of a video signal line coupled to the video monitoring system and a wireless video transmission apparatus, the wireless video transmission apparatus includes a radio transmitter and wirelessly transmits the video signal through one of a first and a second wireless transmission routes, in the first wireless transmission route, the wireless video transmission apparatus compresses the video signal and transmits the compressed video signal to a video receiving apparatus of the video monitoring system through a wireless local area network (LAN), and in the second wireless transmission route, the radio transmitter receives the video signal, transforms the video signal into a radio signal and transmits the radio signal to a radio receiver of the video monitoring system so as to display a video image on a video display apparatus, which is coupled to the radio receiver, of the video monitoring system.

Preferably, the wireless video transmission apparatus receives the first power supply being one of a first AC and a first DC power supplies, and the self-sustained power supply apparatus includes an autogenic energy generating apparatus generating a second AC power supply, a switch determining one of a turn-on and a turn-off states of the generating apparatus, a rectifier rectifying the second AC power supply into a second DC power supply, a regulator regulating the second DC power supply and generating a third DC power supply, a DC/DC converter receiving the third DC power supply and generating the first DC power supply through one of a step-up and a step-down and a DC/AC inverter receiving the third DC power supply and generating the first AC power supply.

Preferably, the wireless video transmission apparatus receives the first power supply being a first DC power supply, and the self-sustained power supply apparatus includes an autogenic energy generating apparatus generating an AC power supply, a switch determining one of a turn-on and a turn-off states of the generating apparatus, a rectifier rectifying the AC power supply into a second DC power supply, a regulator regulating the second DC power supply and generating a third DC power supply and a DC/DC converter receiving the third DC power supply and generating the first DC power supply through one of a step-up and a step-down.

Preferably, the first power supply is one selected from a group consisting of a first AC power supply, a first DC power supply and a second AC power supply, the camera receives one of the first AC power supply and the first DC power supply, the wireless video transmission apparatus receives the first power supply being one of the first DC power supply and the second AC power supply, and the self-sustained power supply apparatus includes an autogenic energy generating apparatus generating a third AC power supply, a switch determining one of a turn-on and a turn-off states of the generating apparatus, a rectifier rectifying the third AC power supply into a second DC power supply, a regulator regulating the second DC power supply and generating a third DC power supply, a DC/DC converter receiving the third DC power supply and generating the first DC power supply through one of a step-up and a step-down, a first DC/AC inverter receiving the third DC power supply and generating the first AC power supply and a second DC/AC inverter receiving the third DC power supply and generating the second AC power supply.

Preferably, the first power supply is one selected from a group consisting of a first AC power supply, a first DC power supply and a second AC power supply, the camera receives one of the first AC power supply and the first DC power supply, the wireless video transmission apparatus receives the first power supply being one of the first DC power supply and the second AC power supply, and the self-sustained power supply apparatus includes an autogenic energy generating apparatus generating a third AC power supply, a switch determining one of a turn-on and a turn-off states of the generating apparatus, a rectifier rectifying the third AC power supply into a second DC power supply, a regulator regulating the second DC power supply and generating a third DC power supply, a DC/DC converter receiving the third DC power supply and generating the first DC power supply through one of a step-up and a step-down, a first DC/AC inverter receiving the first DC power supply and generating the first AC power supply and a second DC/AC inverter receiving the first DC power supply and generating the second AC power supply.

Preferably, the first power supply is one selected from a group consisting of a first AC power supply, a first DC power supply and a second DC power supply, the camera receives one of the first AC power supply and the first DC power supply, the wireless video transmission apparatus receives the first power supply being one of the first AC power supply and the second DC power supply, and the self-sustained power supply apparatus includes an autogenic energy generating apparatus generating a second AC power supply, a switch determining one of a turn-on and a turn-off states Of the generating apparatus, a rectifier rectifying the second AC power supply into a third DC power supply, a regulator regulating the third DC power supply and generating a fourth DC power supply, a first DC/DC converter receiving the fourth DC power supply and generating the first DC power supply through one of a step-up and a step-down, a DC/AC inverter receiving the fourth DC power supply and generating the first AC power supply and a second DC/DC converter receiving the fourth DC power supply and generating the second DC power supply through one of the step-up and the step-down, in which one of the first and the second DC/DC converters, which is going through the step-up, is one selected from a group consisting of a boost converter, a buck-boost converter and a flyback converter, and one of the first and the second DC/DC converters, which is going through the step-down, is one selected from a group consisting of a buck converter, a buck-boost converter, a forward converter, a flyback converter, a half-bridge converter and a full-bridge converter.

Preferably, the first power supply is one selected from a group consisting of a first AC power supply, a first DC power supply and a second DC power supply, the camera receives one of the first AC power supply and the first DC power supply, the wireless video transmission apparatus receives the first power supply being one of the first AC power supply and the second DC power supply, and the self-sustained power supply apparatus includes an autogenic energy generating apparatus generating a second AC power supply, a switch determining one of a turn-on and a turn-off states of the generating apparatus, a rectifier rectifying the second AC power supply into a third DC power supply, a regulator regulating the third DC power supply and generating a fourth DC power supply, a first DC/DC converter receiving the fourth DC power supply and generating the first DC power supply through one of a step-up and a step-down, a DC/AC inverter receiving one of the first and the second DC power supplies and generating the first AC power supply and a second DC/DC converter receiving the fourth DC power supply and generating the second DC power supply through one of the step-up and the step-down.

Preferably, the first power supply is one of a first AC power supply and a first DC power supply, the wireless video transmission apparatus receives a second power supply being one of a second AC power supply and a second DC power supply, and the self-sustained power supply apparatus includes an autogenic energy generating apparatus generating a third AC power supply, a switch determining one of a turn-on and a turn-off states of the generating apparatus, a rectifier rectifying the third AC power supply into a third DC power supply, a regulator regulating the third DC power supply and generating a fourth DC power supply, a first DC/DC converter receiving the fourth DC power supply and generating the first DC power supply through one of a step-up and a step-down, a first DC/AC inverter receiving the fourth DC power supply and generating the first AC power supply, a second DC/DC converter receiving the fourth DC power supply and generating the second DC power supply through one of the step-up and the step-down and a second DC/AC inverter receiving the fourth DC power supply and generating the second AC power supply.

Preferably, the first power supply is one of a first AC power supply and a first DC power supply, the wireless video transmission apparatus receives a second power supply being one of a second AC power supply and a second DC power supply, and the self-sustained power supply apparatus includes an autogenic energy generating apparatus generating a third AC power supply, a switch determining one of a turn-on and a turn-off states of the generating apparatus, a rectifier rectifying the third AC power supply into a third DC power supply, regulator regulating the third DC power supply and generating a fourth DC power supply, first DC/DC converter receiving the fourth DC power supply and generating the first DC power supply through one of a step-up and a step-down, a first DC/AC inverter receiving the first DC power supply and generating the first AC power supply, a second DC/DC converter receiving the fourth DC power supply and generating the second DC power supply through one of the step-up and the step-down and a second DC/AC inverter receiving the second DC power supply and generating the second AC power supply.

Preferably, the wireless video transmission apparatus receives the first power supply being one of a first DC power supply and a second DC power supply, and the self-sustained power supply apparatus includes an autogenic energy generating apparatus generating an AC power supply, a switch determining one of a turn-on and a turn-off states of the generating apparatus, a rectifier rectifying the AC power supply into a third DC power supply, a regulator regulating the third DC power supply and generating a fourth DC power supply, a first DC/DC converter receiving the fourth DC power supply and generating the first DC power supply through one of a step-up and a step-down and a second DC/DC converter receiving the fourth DC power supply and generating the second DC power supply through one of the step-up and the step-down.

Preferably, the wireless video transmission apparatus receives the first power supply being one of a first DC power supply and a second DC power supply, and the self-sustained power supply apparatus includes an autogenic energy generating apparatus generating an AC power supply, a switch determining one of a turn-on and a turn-off states of the generating apparatus, a rectifier rectifying the AC power supply into a third DC power supply, a regulator regulating the third DC power supply and generating a fourth DC power supply, a first DC/DC converter receiving the fourth DC power supply and generating the first DC power supply through one of a step-up and a step-down and a second DC/DC converter receiving the first DC power supply and generating the second DC power supply through one of the step-up and the step-down.

Preferably, one selected from a group consisting of the wireless video transmission apparatus, the self-sustained power supply apparatus and a combination of the wireless video transmission apparatus and the self-sustained power supply apparatus is one of a built-in apparatus and a plug-in apparatus, the built-in apparatus is installed in a specific location inside the camera, and the plug-in apparatus includes a case and a fixing device fixing the case at a surrounding location of the camera.

Preferably, the camera is a CCTV camera, and the video monitoring system is a CCTV monitoring system.

According to the second aspect of the present invention, a wireless door phone system includes an entry panel having a first wireless transceiver transmitting a first trigger signal at a first status of the system, and receiving a first radio frequency signal to generate a first audio signal at a second status of the system, a plurality of telephone extensions, each of which transmits a second trigger signal at a third status of the system and transmits a third trigger signal at a fourth status of the system and an electric control lock having a push-button and generating a fourth trigger signal to unlock and relock in response to one of a situation that the third trigger signal is received by the electric control lock and the push-button is pushed down.

Preferably, the entry panel further includes a trigger signal generator, the first status indicates that the generator is turned on, the second status indicates that the transceiver is turned on through receiving the second trigger signal and the transceiver further receives a first input signal so as to generate a second radio frequency signal, the entry panel further includes a first self-sustained power supply apparatus generating a first power supply for the entry panel, the entry panel is installed at a main entrance of one of an apartment and a building, and the generator is coupled to the apparatus, and coupled to the transceiver, the generator is one of a plurality of first switches each having a push-button and a data input apparatus, the first status indicates a state being one of that the push-button of one of the plurality of first switches is pushed down and that a set of data correctly representing a room number and a floor number of one of the apartment and the building are input via the data input apparatus, and each of the plurality of telephone extensions further includes a second switch having a push-button, a second self-sustained power supply apparatus generating a second power supply for each of the plurality of telephone extensions, a second wireless transceiver coupled to the second self-sustained power supply apparatus and the second switch, turned on to receive the second radio frequency signal so as to generate a first output signal at the third status and turned on to transmit the third trigger signal at the fourth status, a handset having a telephone transmitter and a telephone receiver, in which the telephone receiver is coupled to the second wireless transceiver, and transmits one of a voice and the first output signal at the third status, and the telephone transmitter is coupled to the second wireless transceiver, receives a second input signal, and generates the first radio frequency signal through the second wireless transceiver at the third status and a base unit having a telephone line coupled to the telephone transmitter and the second wireless transceiver includes an open/close switch coupled to the second wireless transceiver, in which the open/close switch is turned on when the handset is off-hook such that the second wireless transceiver is turned on and sends out the second trigger signal to the entry panel at the third status, and the entry panel enters the second status after receiving the second trigger signal and an audio signal generator coupled to the second self-sustained power supply apparatus and the second wireless transceiver, in which the audio signal generator sends out a second output signal and lasts for a first time period when the second wireless transceiver receives a specific first trigger signal at the first status, in which the push-button of the second switch is installed on the base unit, the handset is contained by the base unit when the handset is on-hook, and the second self-sustained power supply apparatus and the second wireless transceiver are installed in the base unit.

Preferably, the third status indicates that the handset is separate from the base unit, and the fourth status indicates that the push-button of the second switch is pushed down and the second switch is turned on.

Preferably, each one of those signals are transmitted and received by one of a radio wave and a combination of a radio wave and a wireless LAN.

Preferably, the door phone system is one of a non-video door phone system and a video door phone system, the first wireless transceiver is a first wireless audio transceiver, the second wireless transceiver is a second wireless audio transceiver, the first input signal is a second audio signal, the first output signal is a third audio signal, the second input signal is a fourth audio signal, the second output signal is a fifth audio signal, and the telephone receiver transmits the third audio signal at the third status when the door phone system is the non-video door phone system.

Preferably, the door phone system is one of a non-video door phone system and a video door phone system, the first wireless transceiver is a first wireless video/audio transceiver, the second wireless transceiver is a second wireless video/audio transceiver, the first input signal is a first video/audio signal, the first output signal is a second video/audio signal, the second input signal is a second audio signal, the second output signal is a third audio signal, the entry panel further includes a camera coupled to the first self-sustained power supply apparatus and the first wireless video/audio transceiver, the first wireless video/audio transceiver turns on the camera at the second status to generate the first video/audio signal, each of the plurality of telephone extensions further includes a display screen coupled to the second self-sustained power supply apparatus and the second wireless video/audio transceiver, the second video/audio signal shows a video image on the display screen and generates the voice, and the telephone receiver transmits the voice at the third status when the door phone system is the video door phone system.

Preferably, the electric control lock further includes a lockset, a third self-sustained power supply apparatus generating a third power supply for the electric control lock and an unlocking/relocking device having a wireless radio receiver, receiving the third trigger signal and coupled to the third self-sustained power supply apparatus, in which the electric control lock is installed on a main entry door of one of the apartment and the building, the unlocking/relocking device is employed to generate the fourth trigger signal to unlock the lockset, an unlocking status of the electric control lock lasts for a second time period , and the electric control lock relocks when a period of the second time period is past.

Preferably, each of the first, the second and the third power supplies is a first DC power supply, each of the first, the second and the third self-sustained power supply apparatuses includes an autogenic energy generating apparatus generating an AC power supply, a switch determining one of a turn-on and a turn-off states of the generating apparatus, a rectifier rectifying the AC power supply into a second DC power supply, a regulator regulating the second DC power supply and generating a third DC power supply and a DC/DC converter receiving the third DC power supply and generating the first DC power supply through one of a step-up and a step-down.

According to the third aspect of the present invention, a wireless door phone system having a first, a second and a third self-sustained power supply apparatuses includes an entry panel having a first wireless transceiver and coupled to the first self-sustained power supply apparatus, in which the transceiver transmits a first trigger signal at a first status, and receives a first radio frequency signal to generate a first audio signal at a second status, a plurality of telephone extensions coupled to the second self-sustained power supply apparatus, in which each of the plurality of telephone extensions transmits a second trigger signal at a third status and transmits a third trigger signal at a fourth status and an electric control lock having a push-button and coupled to the third self-sustained power supply apparatus, in which the electric control lock generates a fourth trigger signal to unlock and relock when one of the third trigger signal is received by the electric control lock and the push-button is pushed down.

Preferably, the door phone system is one of a non-video door phone system and a video door phone system, the first wireless transceiver is a first wireless audio transceiver when the door phone system is the non-video door phone system, and the first wireless transceiver is a first wireless video/audio transceiver when the door phone system is the video door phone system.

The present invention may be best understood through the following descriptions with reference to the accompanying drawings, in which:

### BRIEF DESCRIPTION OF THE DRAWINGS

FIG. 1 is the schematic diagram showing the configuration of a conventional CCTV monitoring system having a CCTV camera system;

FIG. 2 is the schematic diagram showing the configuration of a conventional non-video door phone system;

FIG. 3 is the schematic diagram showing the configuration of a conventional video door phone system;

FIG. 4 is the schematic diagram showing the configuration of an autogenic energy generating device in the prior art;

FIGS. 5(a) to 5(f) are the schematic circuit diagrams of a CCTV monitoring system having a CCTV camera system including a plug-in self-sustained power supply apparatus according to the first to the sixth preferred embodiments of the CCTV camera system of the present invention respectively;

FIGS. 5(g) to 5(l) are the schematic circuit diagrams of a CCTV monitoring system having a CCTV camera system including a built-in self-sustained power supply apparatus according to the seventh to the twelfth preferred embodiments of the CCTV camera system of the present invention respectively;

FIGS. 6(a) and 6(b) are showing the circuit diagrams of a half-wave bridge rectifier and a full-wave bridge rectifier, and employed in the preferred embodiments of the present invention respectively;

FIGS. 7(a) to 7(c) are showing the circuit diagrams of a NPN voltage regulator, a LDO voltage regulator and a Quasi LDO voltage regulator, which are linear voltage regulators, and employed in the preferred embodiments of the present invention respectively;

FIGS. 8(a) to 8(c) are showing the circuit diagrams of a buck converter, a boost converter and a buck-boost converter, which are DC/DC converters, and employed in the preferred embodiments of the present invention respectively;

FIGS. 9(a) and 9(b) are showing the circuit diagrams of a single phase half-bridge inverter and a single phase full-bridge inverter, which are DC/AC inverters, and employed in the preferred embodiments of the present invention respectively;

FIG. 10 is showing the schematic diagram of a CCTV monitoring system having a CCTV camera system including a built-in self-sustained power supply apparatus according to the seventh to the twelfth preferred embodiments of the CCTV camera of the present invention;

FIGS. 11(a) and 11(b) are showing the schematic circuit diagrams of a non-video door phone system having three self-sustained power supply apparatuses according to the first and the second preferred embodiments of the non-video door phone system of the present invention; and

FIGS. 12(a) and 12(b) are showing the schematic circuit diagrams of a video door phone system having three self-sustained power supply apparatuses according to the first and the second preferred embodiments of the video door phone system of the present invention.

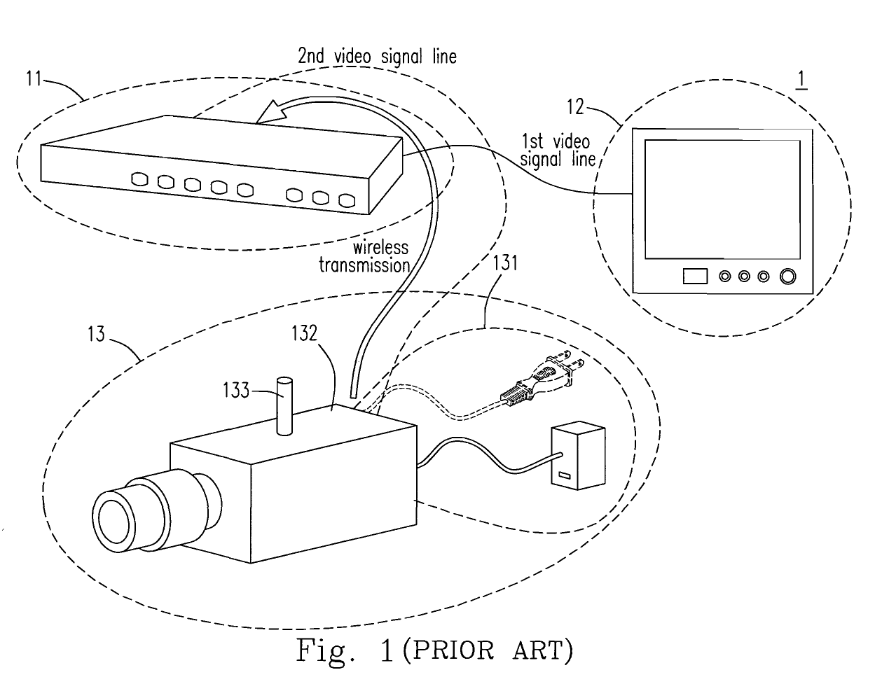

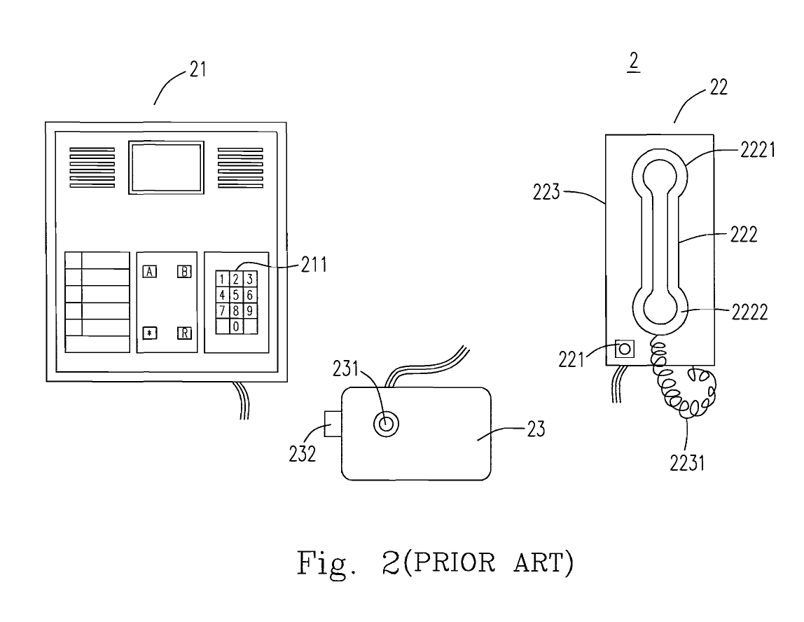

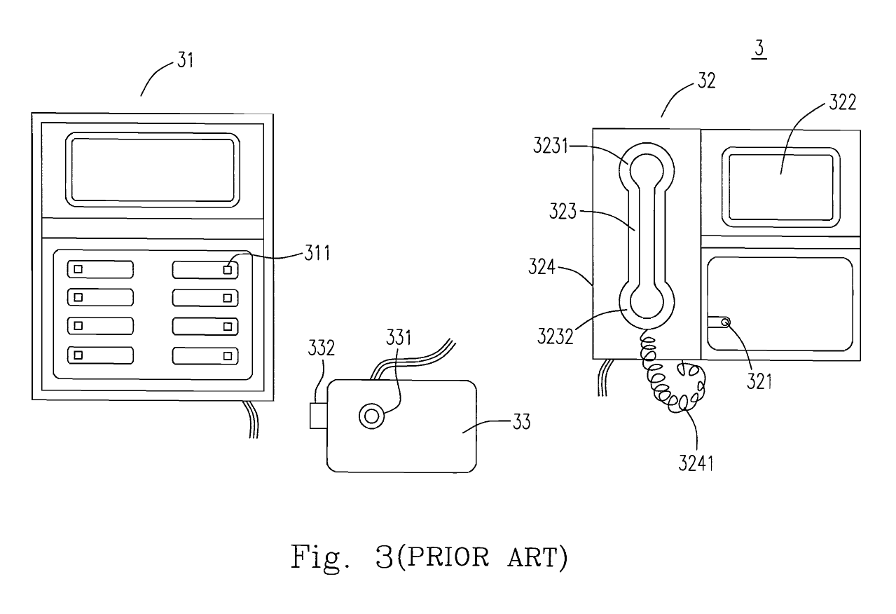

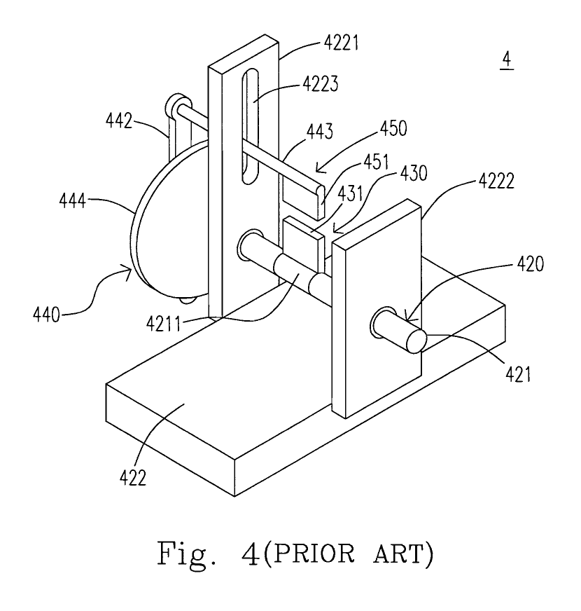

### DETAILED DESCRIPTION OF THE PREFERRED EMBODIMENT

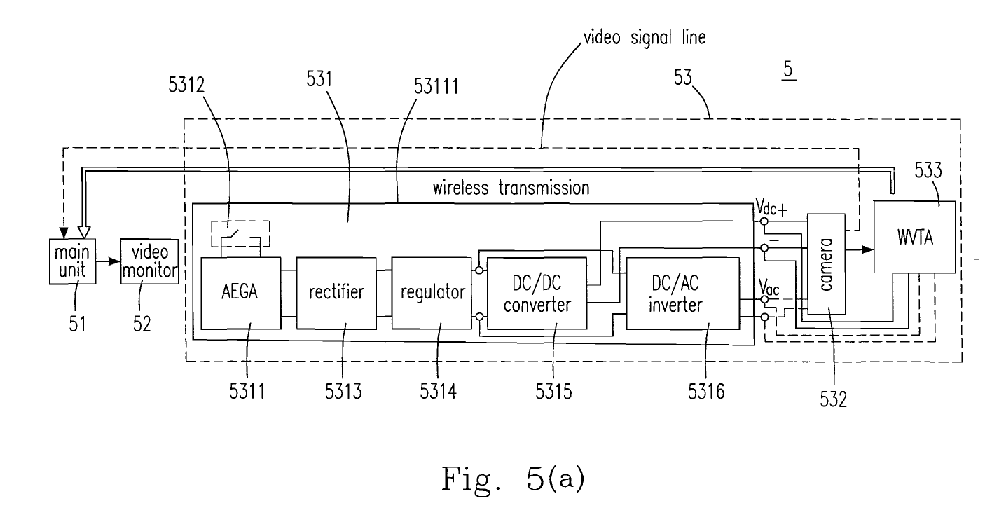

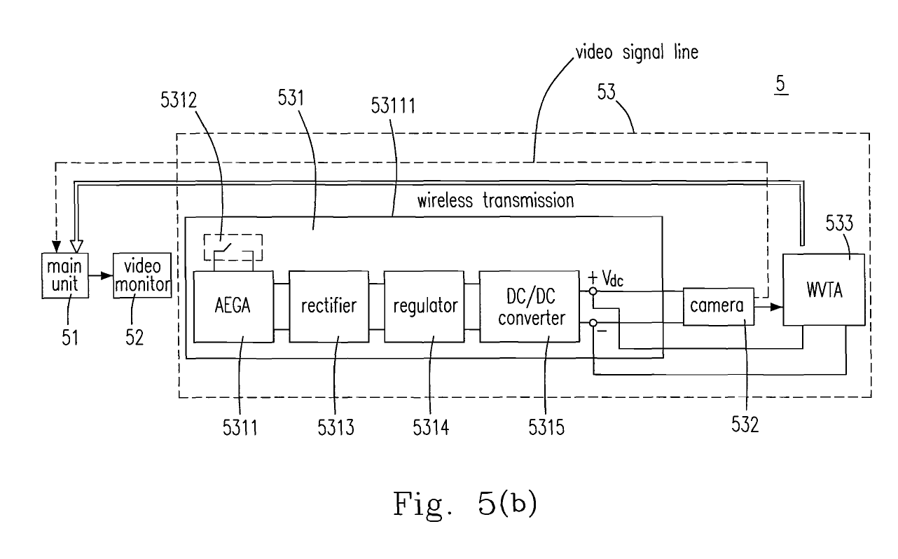

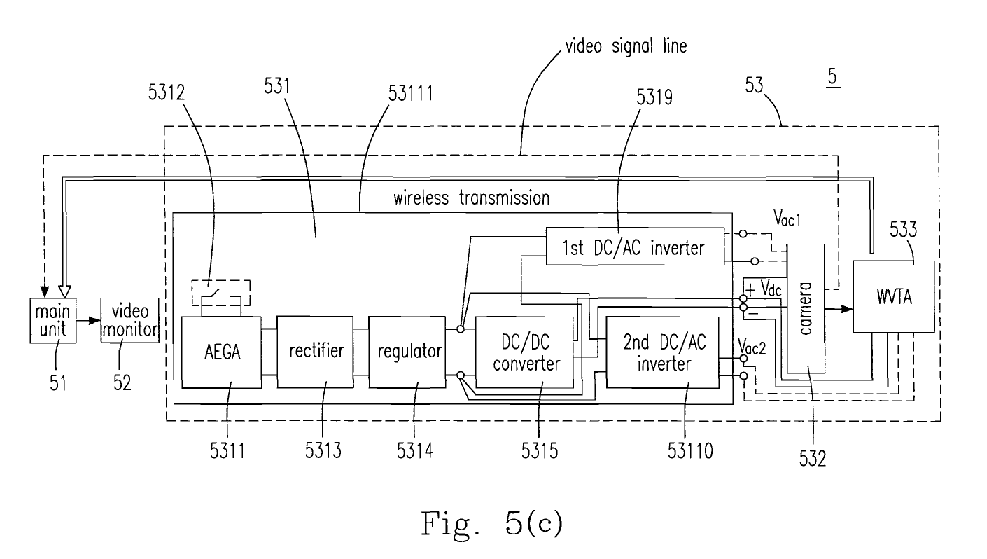

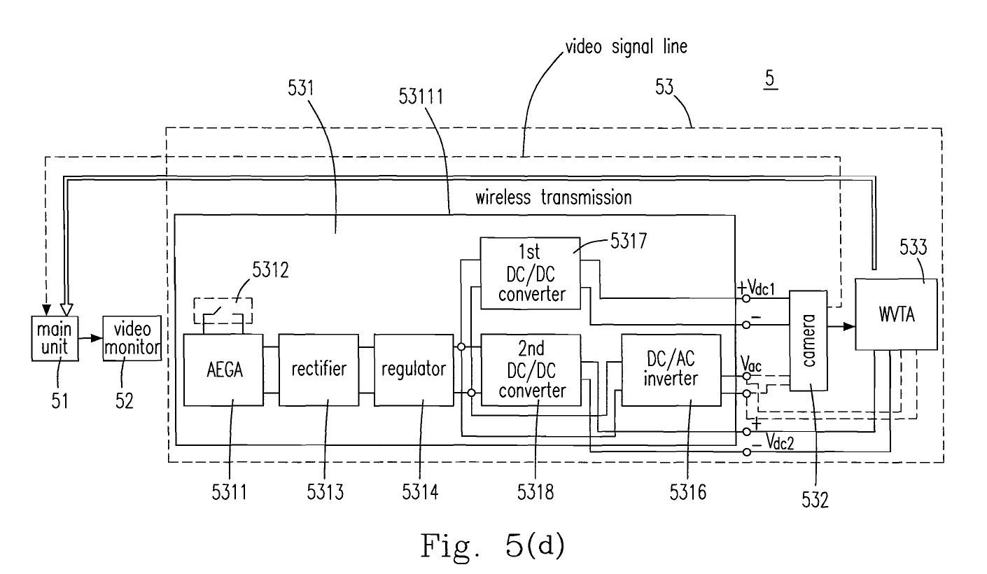

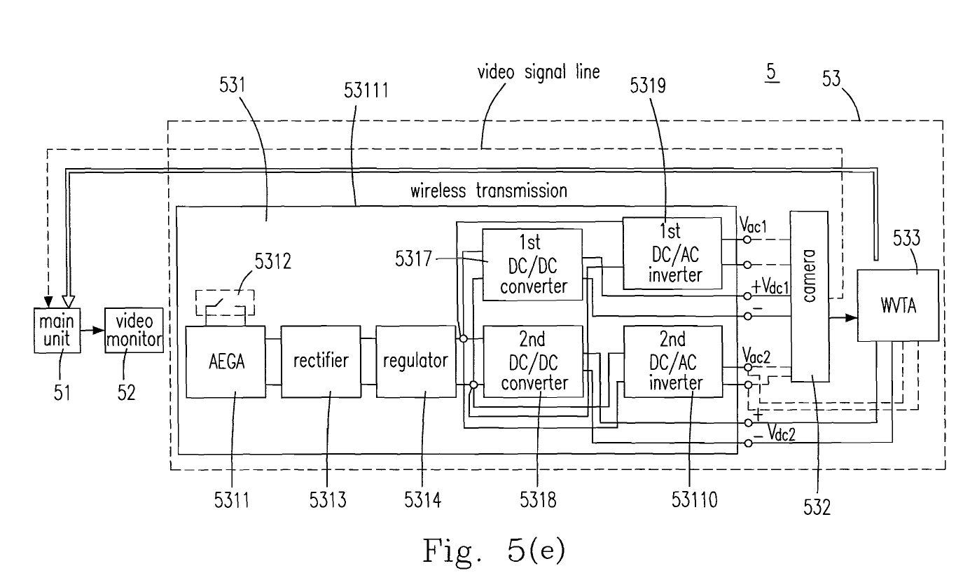

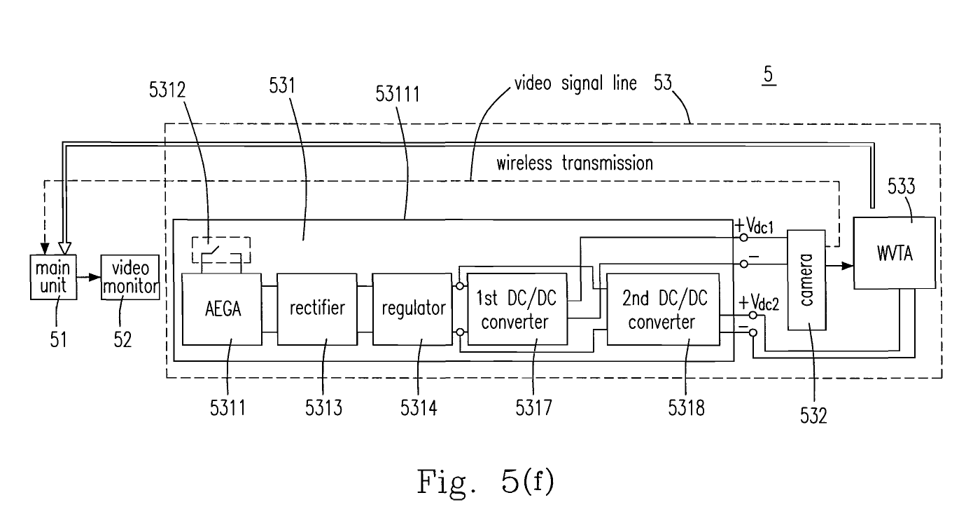

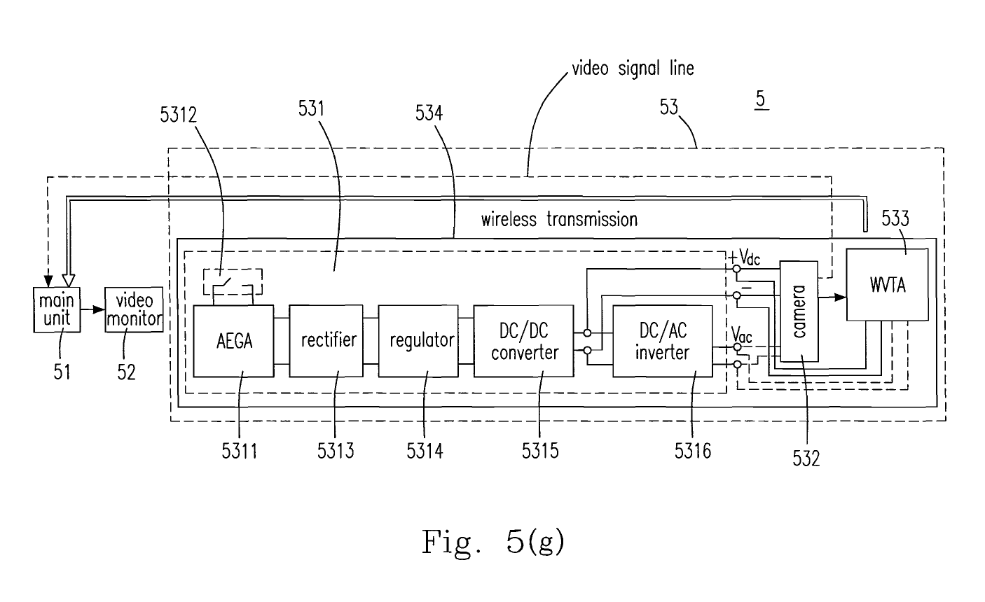

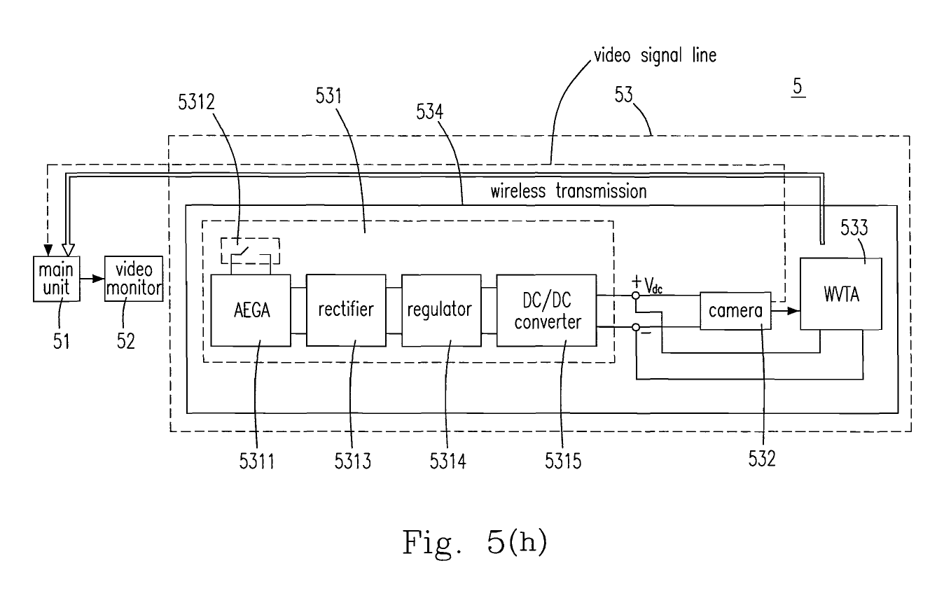

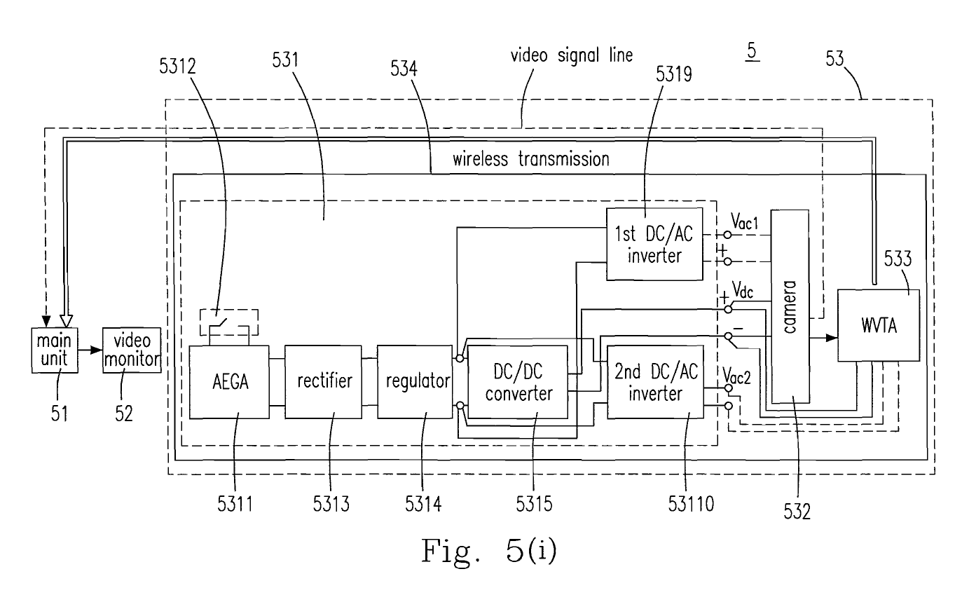

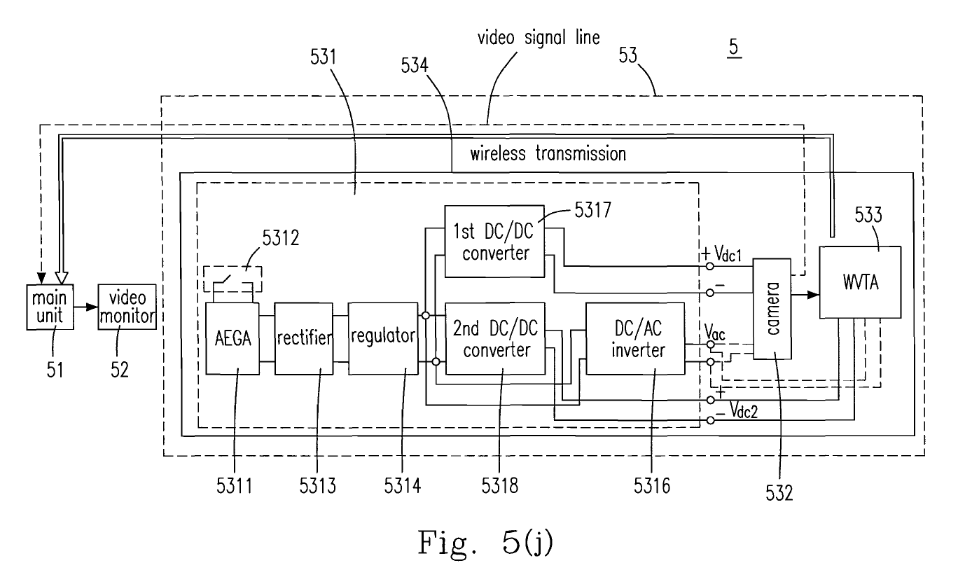

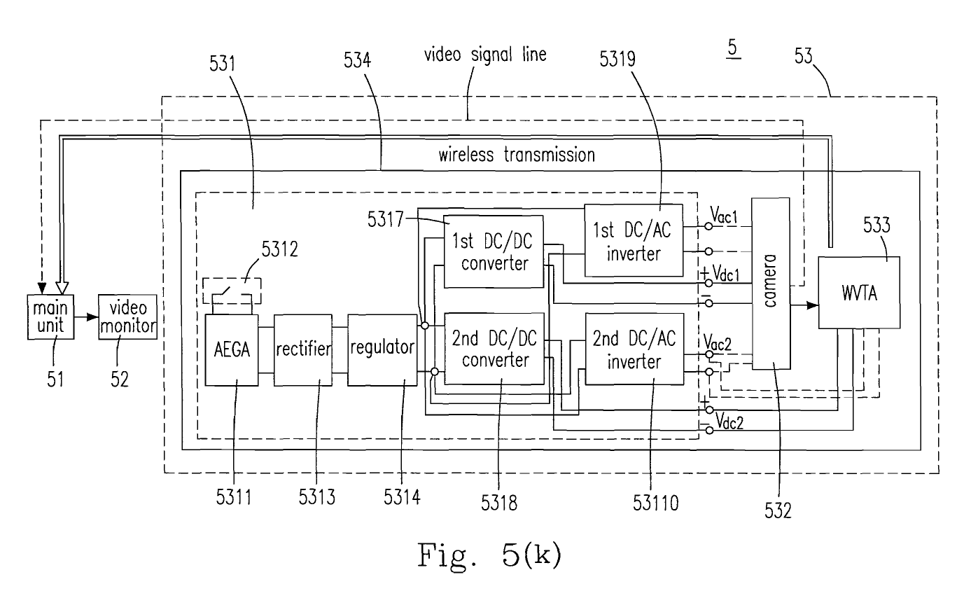

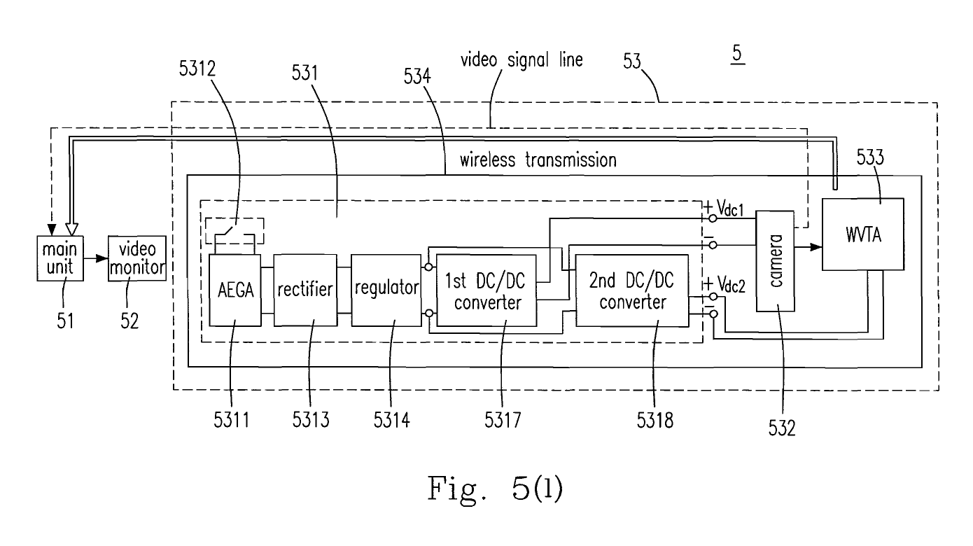

Please refer to FIG. 5(a), which shows the schematic circuit diagrams of a CCTV monitoring system having a CCTV camera system including a plug-in self-sustained power supply apparatus according to the first preferred embodiment of the CCTV camera system of the present invention. In FIG. 5(a), the CCTV monitoring system 5 includes a main unit 51, a video monitor (or a video receiving apparatus, not shown) 52 and a CCTV camera system having a plug-in self-sustained power supply apparatus 53. The CCTV camera system 53 includes a plug-in self-sustained power supply apparatus 531, a camera 532 and a wireless video transmission apparatus (WVTA) 533. In which, the camera 532 is coupled to the plug-in self-sustained power supply apparatus 531 and receives a first power supply, and the WVTA 533 is coupled to the plug-in self-sustained power supply apparatus 531 and the camera 532 so as to transmit a video signal generated by the camera 532 to the main unit 51 of the CCTV monitoring system 5 via a wireless transmission. The WVTA 533 includes a radio receiver (not shown) and has a first and a second wireless transmission routes, and the wireless transmission could go through one of the first and the second wireless transmission routes. In the first wireless transmission route, the WVTA 533 compresses the video signal and transmits the compressed video signal to a video receiving apparatus (not shown, corresponding to the video monitor 52) of the video monitoring system 5 through a wireless LAN (not shown). In the second wireless transmission route, the WVTA 533 receives the video signal, transforms the video signal into a radio signal, and transmits the radio signal to a radio receiver (not shown) of the video monitoring system 5 so as to display a video image on a video display apparatus (not shown, corresponding to the video monitor 52), which is coupled to the radio receiver, of the video monitoring system 5. The video signal generated by the camera 532 could also be transmitted to the main unit 51 of the monitoring system 5 through a video signal line (as shown in dash lines). Besides, the video monitor 52 is coupled to the main unit 51 to display a video image. In which, the first power supply is one of a first AC power supply Vac (as shown in dash lines) and a first DC power supply Vdc (as shown in solid lines). Thus, both of the camera 532 and the WVTA 533 could receive one of the first AC power supply Vac and the first DC power supply Vdc. The plug-in self-sustained power supply apparatus 531 includes an autogenic energy generating apparatus (AEGA) 5311 having an autogenic energy generating device (not shown) generating a kinetic energy and an AC generator (not shown) receiving the kinetic energy and generating an AC power supply continuously, a switch 5312 coupled to the AEGA 5311 and turning on and off the AEGA 5311, a rectifier 5313 coupled to the AEGA 5311 rectifying the AC power supply into a second DC power supply, a regulator 5314 coupled to the rectifier 5313 regulating the second DC power supply to generate a third DC power supply, a DC/DC converter 5315 coupled to the regulator 5314, receiving the third DC power supply and going through one of a step-up and a step-down to generate the first DC power supply Vdc, a DC/AC inverter 5316 coupled to the regulator 5314, receiving the third DC power supply and generating the first AC power supply Vdc and a case 53111 containing the components 5311 to 5316 of the self-sustained power supply system 531. In a different preferred embodiment (not shown), the aforementioned DC/AC inverter 5316 could also be coupled to the DC/DC converter 5315, receives the first DC power supply Vdc and generates the first AC power supply Vac.

Referring to FIG. 5(b), which shows the schematic circuit diagram of a CCTV monitoring system having a CCTV camera system including a plug-in self-sustained power supply apparatus according to the second preferred embodiment of the CCTV camera system of the present invention. The differences between the second and first preferred embodiments of the CCTV monitoring system 5 having a CCTV camera system 53 including a plug-in self-sustained power supply apparatus 531 are that the first power supply is a first DC power supply Vdc thus the DC/AC inverter 5316 of the self-sustained power supply apparatus 531 as shown in FIG. 5(a) is not included in FIG. 5(b), the plug-in self-sustained power supply apparatus 531 only generates the first DC power supply Vdc, and both of the camera 532 and the WVTA 533 only receive the first DC power supply Vdc.

FIG. 5(c) is the schematic circuit diagram of a CCTV monitoring system having a CCTV camera system including a plug-in self-sustained power supply apparatus according to the third preferred embodiment of the CCTV camera system of the present invention. The differences between the third preferred embodiment of the present invention as shown in FIG. 5(c) and the first and the second preferred embodiments of the present invention as shown in FIGS. 5(a) and 5(b) are that the camera 532 is coupled to the plug-in self-sustained power supply apparatus 531 and receives the first power supply being one selected from a group consisting of a first AC power supply Vac1(as shown in dash lines), a first DC power supply Vdc (as shown in solid lines) and a second AC power supply Vac2 (as shown in dash lines), the camera receives one of the first AC power supply Vac1 and the first DC power supply Vdc, the WVTA 533 receives the first power supply being one of the first DC power supply Vdc and the second AC power supply Vac2. Thus, the plug-in self-sustained power supply apparatus 531 includes not only the components 5311 to 5315 as shown in FIGS. 5(a) and 5(b) and generates the first DC power supply Vdc, but also a first DC/AC inverter 5319 and a second DC/AC inverter 53110 coupled to the regulator 5314, receiving the third DC power supply and generating the first AC power supply Vac1 and the second AC power supply Vac2. In a different preferred embodiment (not shown), the aforementioned first DC/AC inverter 5319 and a second DC/AC inverter 53110 could also be coupled to the DC/DC converter 5315, receives the first DC power supply Vdc and generates the first AC power supply Vac1 and the second AC power supply Vac2.

Please refer to FIG. 5(d), which shows the schematic circuit diagram of a CCTV monitoring system having a CCTV camera system including a plug-in self-sustained power supply apparatus according to the fourth preferred embodiment of the CCTV camera system of the present invention. The differences between the fourth preferred embodiment and the first to the third preferred embodiments of the present invention are that the camera 532 is coupled to the plug-in self-sustained power supply apparatus 531 and receives the first power supply, which is one selected from a group consisting of a first DC power supply Vdc1 (as shown in solid lines), a second DC power supply Vdc2 (as shown in solid lines) and a first AC power supply Vac (as shown in dash lines), the camera receives one of the first DC power supply Vdc1 and the first AC power supply Vac, the WVTA 533 receives the first power supply being one of the first AC power supply Vac and the second DC power supply Vdc2. Thus, the plug-in self-sustained power supply apparatus 531 includes not only the components 5311 to 5314 and 5316 as shown in FIGS. 5(a) to 5(c) and generates the first AC power supply Vac, but also a first DC/DC converter 5317 and a second DC/DC converter 5318 coupled to the regulator 5314, receiving the third DC power supply and generating the first DC power supply Vdc1 and the second DC power supply Vdc2. In a different preferred embodiment (not shown), the aforementioned DC/AC inverter 5316 could also be coupled to one of the first DC/DC converter 5317 and the second DC/DC converter 5318, receives one of the first DC power supply Vdc1 and the second DC power supply Vdc2 respectively, and generates the first AC power supply Vac.

Please refer to FIG. 5(e), which shows the schematic circuit diagram of a CCTV monitoring system having a CCTV camera system including a plug-in self-sustained power supply apparatus according to the fifth preferred embodiment of the CCTV camera system of the present invention. The differences between the fifth preferred embodiment and the first to the fourth preferred embodiments of the present invention are that the camera 532 is coupled to the plug-in self-sustained power supply apparatus 531 and receiving the first power supply being one of a first DC power supply Vdc1 (as shown in solid lines) and a first AC power supply Vac1 (as shown in dash lines), and the WVTA 533 is coupled to the plug-in self-sustained power supply apparatus 531 and receiving the second power supply being one of the second DC power supply Vdc2 (as shown in solid lines) and the second AC power supply Vac2 (as shown in dash lines). Thus, the plug-in self-sustained power supply apparatus 531 includes the components 5311 to 5314 and 5317 to 53110 as shown in FIGS. 5(a) to 5(d) and generates the first DC power supply Vdc1, the first AC power supply Vac1, the second DC power supply Vdc2 and the second AC power supply Vac2 respectively. In a different preferred embodiment (not shown), the aforementioned first and the second DC/AC inverters 5319 and 5310 could also be coupled to one of the first DC/DC converter 5317 and the second DC/DC converter 5318, receives the first DC power supply Vdc1 and the second DC power supply Vdc2 respectively, and generates the first AC power supply Vac1 and the second AC power supply Vac2.

Please refer to FIG. 5(f), which shows the schematic circuit diagram of a CCTV monitoring system having a CCTV camera system including a plug-in self-sustained power supply apparatus 531 according to the sixth preferred embodiment of the CCTV camera system of the present invention. The differences between the sixth preferred embodiment and the first to the fifth preferred embodiments of the present invention are that the camera 532 is coupled to the plug-in self-sustained power supply apparatus 531 and receives the first power supply being a first DC power supply Vdc1 (as shown in solid lines), and the WVTA 533 is coupled to the plug-in self-sustained power supply apparatus 531 and receives a second power supply being a second DC power supply Vdc2 (as shown in solid lines). Thus, the plug-in self-sustained power supply apparatus 531 includes the components 5311 to 5314 and 5317 to 5318 as shown in FIGS. 5(a) to 5(d) and generates the first DC power supply Vdc1 and the second DC power supply Vdc2 respectively. In a different preferred embodiment (not shown), the aforementioned second DC/DC converter 5318 could also be coupled to the first DC/DC converter 5317, receives the first DC power supply Vdc1 and generates the second DC power supply Vdc2.

In the above-mentioned first to the sixth preferred embodiments of the present invention as shown in FIGS. 5(a) to 5(f), the WVTA 533 could also be contained inside one of the plug-in self-sustained power supply system 531 and the camera 532.

Please refer to FIGS. 5(g) to 5(l), which are the schematic circuit diagrams of a CCTV monitoring system 5 having a CCTV camera system 53 including a bult-in self-sustained power supply apparatus 531 according to the seventh to the twelfth preferred embodiments of the CCTV camera system of the present invention, which are corresponding to the aforementioned first to the sixth preferred embodiments as shown in FIGS. 5(a) to 5(f). The differences between the seventh to the twelfth preferred embodiment and the first to the sixth preferred embodiments of the present invention are that each of the built-in self-sustained power supply apparatuses 531 does not have the case 53111 in the seventh to the twelfth preferred embodiments of the CCTV camera system of the present invention, and the CCTV camera system 53 has a case 534, which is employed to contain the built-in self-sustained power supply apparatuses 531, the camera 532 and the WVTA 533.

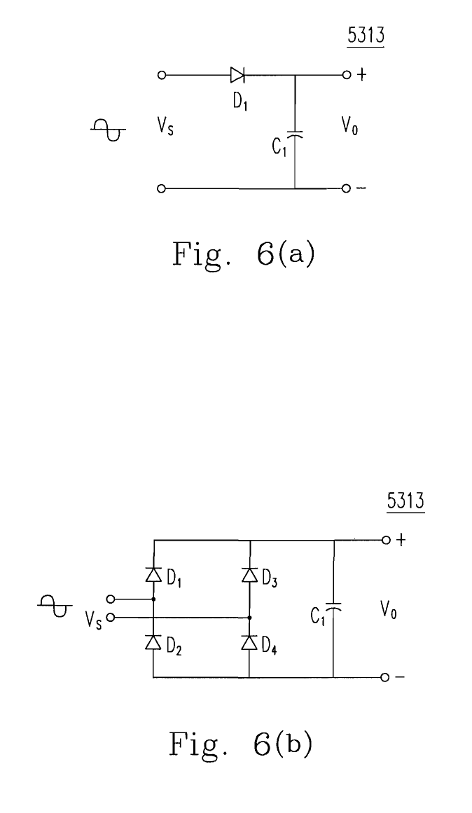

As for the rectifier 5313 included in the above-mentioned first to the twelfth preferred embodiments of a CCTV monitoring system 5 having a CCTV camera system 53 including a self-sustained power supply apparatus 531 of the present invention as shown in FIGS. 5(a) to 5(l), it could be one of a half-wave bridge rectifier and a full-wave bridge rectifier. FIGS. 6(a) and 6(b) are the schematic circuit diagrams of the half-wave bridge rectifier and the full-wave bridge rectifier. In FIG. 6(a), the half-wave bridge rectifier includes a diode D1 and a filter capacitor C1, the input voltage of the half-wave bridge rectifier is an AC voltage Vs, and the output voltage of the half-wave bridge rectifier is DC voltage Vo. In FIG. 6(b), the full-wave bridge rectifier includes four diodes D1-D4 and a filter capacitor C1, the input voltage of the full-wave bridge rectifier is an AC voltage Vs, and the output voltage of the full-wave bridge rectifier is a DC voltage Vo. Besides, other different types of rectifiers are also applicable to the first to the twelfth preferred embodiments of the CCTV camera system of the present invention. Since the technology regarding the conventional rectifiers is a well-known prior art, the details regarding the contents of the technology would be omitted here.

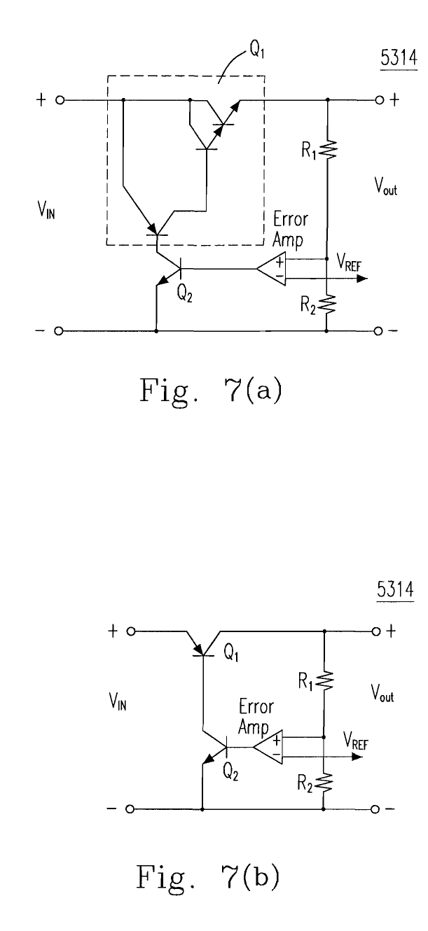

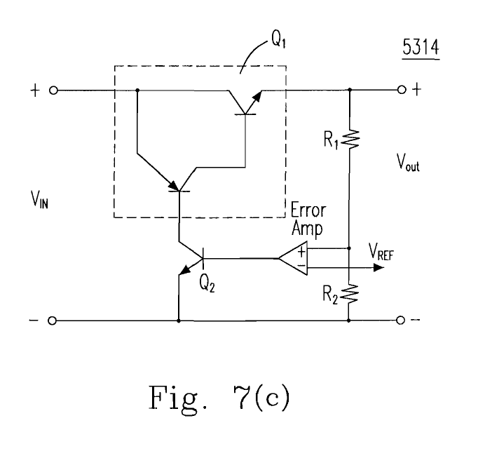

As for the regulator 5314 included in the above-mentioned first to the twelfth preferred embodiments of a CCTV monitoring system 5 having a CCTV camera system 53 including a self-sustained power supply apparatus 531 of the present invention as shown in FIGS. 5(a) to 5(l), it could be a linear voltage regulator, that is to say it could be one selected from a group consisting of an NPN voltage regulator, a LDO voltage regulator and a Quasi LDO voltage regulator. FIGS. 7(a) to 7(c) are the schematic circuit diagrams of the NPN voltage regulator, the LDO voltage regulator and the Quasi LDO voltage regulator. In FIG. 7(a), the NPN voltage regulator includes a pass device Q1 (having a Darlington transistor and a PNP transistor), a NPN transistor Q2, an error amplifier Error Amp and a voltage divider (having resistors R1 and R2). In which, the output terminal of the Error Amp is coupled to the base of the transistor Q2, the inverting input terminal of the Error Amp is coupled to a connecting terminal of R1 and R2, and the non-inverting input terminal of the Error Amp is coupled to a reference voltage V_{REF}, the input voltage of the NPN voltage regulator is a DC voltage V_{IN}, and the output voltage of the NPN voltage regulator is a DC voltage V_{OUT}. In FIG. 7(b), the pass device Q1 of the LDO voltage regulator is a PNP transistor, and the remaining part is the same as the above-mentioned NPN voltage regulator. In FIG. 7(c), the pass device Q1 of the Quasi LDO voltage regulator includes a PNP transistor and a NPN transistor coupled to each other, the remaining part is the same as the above-mentioned NPN voltage regulator. Besides, other different types of regulators are also applicable to the first to the twelfth preferred embodiments of the CCTV camera system of the present invention. Since the technology regarding the conventional regulators is a well-known prior art, the details regarding the contents of the technology would be omitted here.

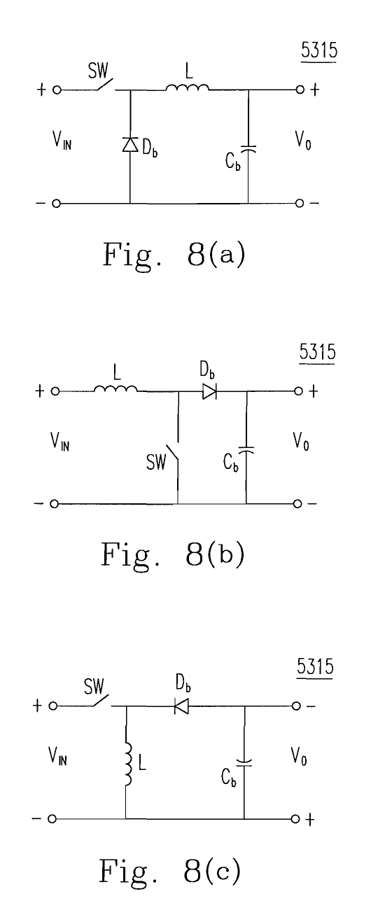

As for the DC/DC converter 5315 included in the above-mentioned first to the twelfth preferred embodiments of a CCTV monitoring system 5 having a CCTV camera system 53 including a self-sustained power supply apparatus 531 of the present invention as shown in FIGS. 5(a) to 5(l), it could be one of a buck converter, a boost converter and a buck-boost converter. FIGS. 8(a) to 8(c) are the schematic circuit diagrams of the buck converter, the boost converter and the buck-boost converter. In FIG. 8(a), the buck converter includes a switch SW, a diode Db, an inductor L and an output capacitor Cb. In which, the input voltage of the buck converter is a DC voltage V_{IN}, and the output voltage of the boost converter is a DC voltage V_{O}. In FIG. 8(b), the boost converter includes the same components as the aforementioned buck converter, and except that the connecting configuration of the boost converter is different from that of the buck converter, the remaining part is the same as the above-mentioned buck converter. In FIG. 8(c), the buck-boost converter includes the same components as the aforementioned buck converter, and except that the connecting configuration of the buck-boost converter is different from that of the buck converter, the remaining part is the same as the above-mentioned buck converter. Besides, other different types of converters are also applicable to the first to the twelfth preferred embodiments of the CCTV camera system of the present invention. Since the technology regarding the conventional converters is a well-known prior art, the details regarding the contents of the technology would be omitted here.

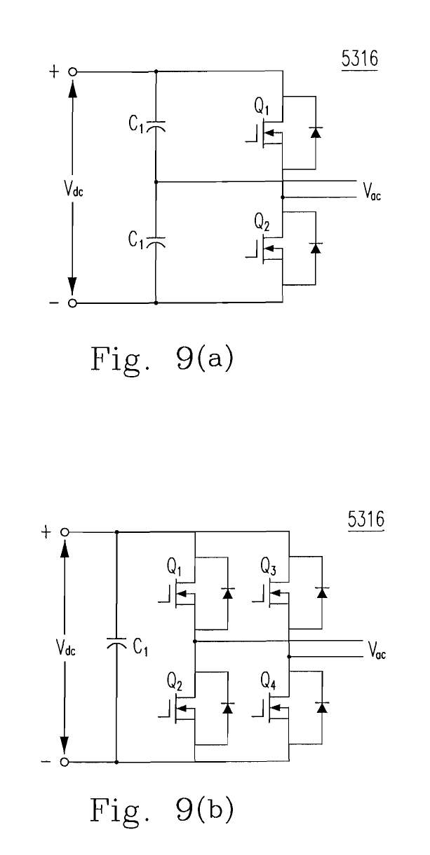

As for the DC/AC inverter 5316 included in the above-mentioned first to the twelfth preferred embodiments of a CCTV monitoring system 5 having a CCTV camera system 53 including a self-sustained power supply apparatus 531 of the present invention as shown in FIGS. 5(a) to 5(l), it could be one of a single-phase half-bridge inverter and a single-phase full-bridge inverter. FIGS. 9(a) and 9(b) are the circuit diagrams of the single-phase half-bridge inverter and the single-phase full-bridge inverter. In FIG. 9(a), the single-phase half-bridge inverter includes two filter capacitors C1 and C2 and two power switches Q1 and Q2. In which, the input voltage of the single-phase half-bridge inverter is a DC voltage Vdc, and the output voltage of the single-phase half-bridge inverter is an AC voltage Vac. In FIG. 9(b), the single-phase full-bridge inverter includes a filter capacitor C1 and four power switches Q1 to Q4, the input voltage of the single-phase full-bridge inverter is a DC voltage Vdc, and the output voltage of the single-phase full-bridge inverter is an AC voltage Vac. Besides, other different types of inverters are also applicable to the first to the twelfth preferred embodiments of the CCTV camera system of the present invention. Since the technology regarding the conventional inverters is a well-known prior art, the details regarding the contents of the technology would be omitted here.

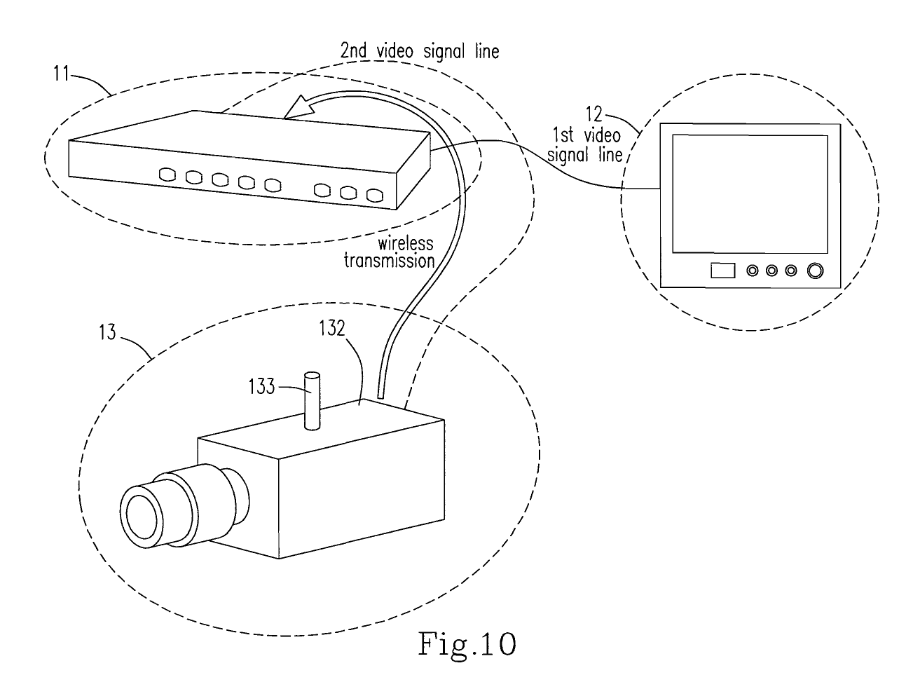

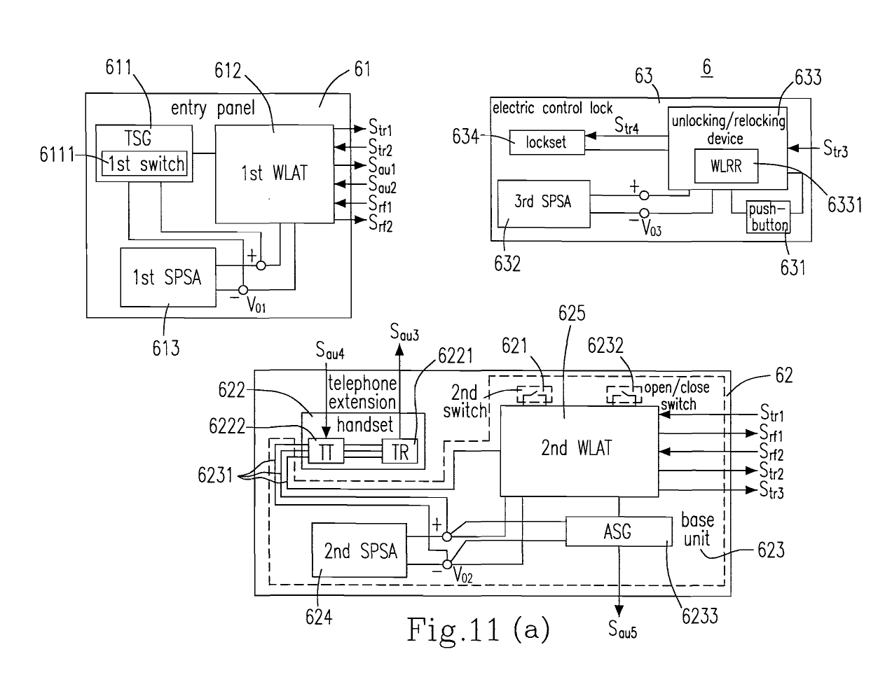

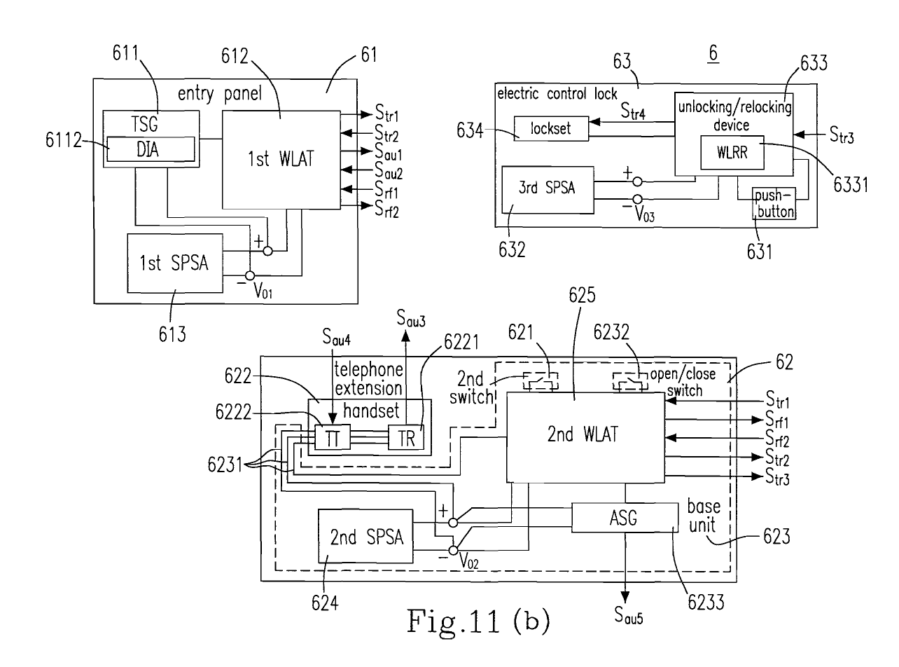

Please refer to FIG. 10, which is the schematic circuit diagram of a CCTV monitoring system having a CCTV camera system including a built-in self-sustained power supply apparatus according to the seventh to the twelfth preferred embodiments of the CCTV camera of the present invention. In FIG. 10, the CCTV monitoring system 5 includes a main unit 51, a video monitor 52 coupled to the main unit 51 through a first video signal line to display a video image and a CCTV camera system 53 having a built-in self-sustained power supply apparatus 531. The CCTV camera system 53 includes a built-in self-sustained power supply apparatus 531 (not shown, could also be a plug-in self-sustained power supply apparatus), a camera 532 and a WVTA 533 (not shown), a case 534 and a support 535. The WVTA 533 is coupled to the camera 532 and transmits a video signal generated by the camera 532 to the main unit 51 of the CCTV monitoring 5 via one of a wireless transmission and a second video signal line (as shown in dash lines). The WVTA 533 includes a radio receiver (not shown) and has a first and a second wireless transmission routes, and the wireless transmission could go through one of the first and the second wireless transmission routes. In the first wireless transmission route, the WVTA 533 compresses the video signal and transmits the compressed video signal to a video receiving apparatus (not shown) of the video monitoring system 5 through a wireless LAN (not shown). In the second wireless transmission route, the WVTA 533 receives the video signal, transforms the video signal into a radio signal, and transmits the radio signal to a radio receiver (not shown) of the video monitoring system 5 so as to display a video image on a video display apparatus (not shown, corresponding to the video monitor 52), which is coupled to the radio receiver, of the video monitoring system 5. Please refer to FIG. 11(a), it shows the schematic circuit diagrams of a non-video door phone system having three self-sustained power supply apparatuses according to the first preferred embodiment of the non-video door phone system of the present invention. In FIG. 11(a), the non-video door phone system 6 includes an entry panel 61, a plurality of telephone extensions 62 and an electric control lock 63. In which, the entry panel 61 includes a trigger signal generator (TSG) 611, a first wireless transceiver (1^{st} WLAT) 612 transmitting a first trigger signal Str1 at a first status of the system, and receiving a first radio frequency signal Srf1 to generate a first audio signal Sau1 at a second status of the system, and a first self-sustained power supply apparatus (1^{st} SPSA) 613 providing a first DC power supply Vo1. The plurality of telephone extensions 62, each of which transmits a second trigger signal Str2 at a third status of the system and transmits a third trigger signal Str3 at a fourth status of the system and the electric control lock 63 having a push-button 631 and generating a fourth trigger signal Str4 to unlock and relock in response to one of a situation that the third trigger signal Str3 is received by the electric control lock 63 and the push-button 631 is pushed down.

The first status indicates that the TSG 611 is turned on, the second status indicates that the 1^{st} WLAT is turned on through receiving the second trigger signal Str2 and the 1^{st} WLAT further receives a first input signal (a second audio signal Sau2) so as to generate a second radio frequency signal Srf2, the entry panel 61 further includes the first self-sustained power supply apparatus (1^{st} SPSA) 613 generating a first power supply Vo1 for the entry panel 61, the entry panel 61 is installed at a main entrance of one of an apartment and a building, and the TSG 611 is coupled to the 1^{st} SPSA 613, and coupled to the 1^{st} WLAT 612, the TSG 611 is one of a plurality of first switches 6111 each having a push-button and a data input apparatus (DIA) 6112 (see FIG. 11(b)), the first status indicates a state being one of that the push-button of one of the plurality of first switches 6111 is pushed down and that a set of data correctly representing a room number and a floor number of one of the apartment and the building are input via the DIA 6112, and each of the plurality of telephone extensions 62 further includes a second switch 621 having a push-button, a second self-sustained power supply apparatus (2^{nd} SPSA) 624 generating a second power supply Vo2 for each of the plurality of telephone extensions 62, a second wireless audio transceiver (2^{nd} WLAT) 625 coupled to the 2^{nd} SPSA 624 and the second switch 621, turned on to receive the second radio frequency signal Srf2 so as to generate a first output signal (a third audio signal Sau3) at the third status and turned on to transmit the third trigger signal Str3 at the fourth status, a handset 622 having a telephone transmitter (TT) 6222 and a telephone receiver (TR) 6221, in which the TR 6221 is coupled to the 2^{nd} WLAT 625, and transmits one of a voice (a visitor's voice when it is a video door phone system) and the first output signal (Sau3, also the visitor's voice when it is a non-video door phone system) at the third status, and the TT 6222 is coupled to the 2^{nd} WLAT 625, receives a second input signal (a fourth audio signal) Sau4, and generates the first radio frequency signal Srf1 through the 2^{nd} WLAT 625 at the third status and a base unit 623 having a telephone line 6231 coupled to the TT 6222 and the 2^{nd} WLAT 625 includes an open/close switch 6232 coupled to the 2nd WLAT 625, in which the open/close switch 6232 is turned on when the handset 622 is off-hook such that the 2^{nd} WLAT 625 is turned on and sends out the second trigger signal Str2 to the entry panel 61 at the third status, and the entry panel 61 enters the second status after receiving the second trigger signal Str2 and an audio signal generator (ASG) 6233 coupled to the 2^{nd} SPSA 624 and the 2^{nd} WLAT 625, in which the ASG 6233 sends out a second output signal (a fifth audio signal Sau5) and lasts for a first time period when the 2^{nd} WLAT 625 receives a specific first trigger signal Str1 at the first status, in which the push-button of the second switch 621 is installed on the base unit 623, the handset 622 is contained by the base unit 623 when the handset 622 is on-hook, and the 2^{nd} SPSA 624 and the 2^{nd} WLAT 625 are installed in the base unit 623.

The third status indicates that the handset 622 is separate from the base unit 623, and the fourth status indicates that the push-button of the second switch 621 is pushed down and the second switch 621 is turned on. Each one of those signals are transmitted and received by one of a radio wave and a combination of a radio wave and a wireless LAN. Referring to FIG. 11(a) again, the telephone receiver TR 6221 transmits the third audio signal Sau3 at the third status.

The electric control lock 63 further includes a lockset 634, a third self-sustained power supply apparatus (3^{rd} SPSA) 632 generating a third power supply Vo3 for the electric control lock 63 and an unlocking/relocking device 633 having a wireless radio receiver (WLRR) 6332, receiving the third trigger signal Str3 and coupled to the 3^{rd} SPSA 632, in which the electric control lock 63 is installed on a main entry door of one of the apartment and the building, the unlocking/relocking device 633 is employed to generate the fourth trigger signal Str4 to unlock the lockset 634, an unlocking status of the electric control lock 63 lasts for a second time period, and the electric control lock 63 relocks when a period of the second time period is past.

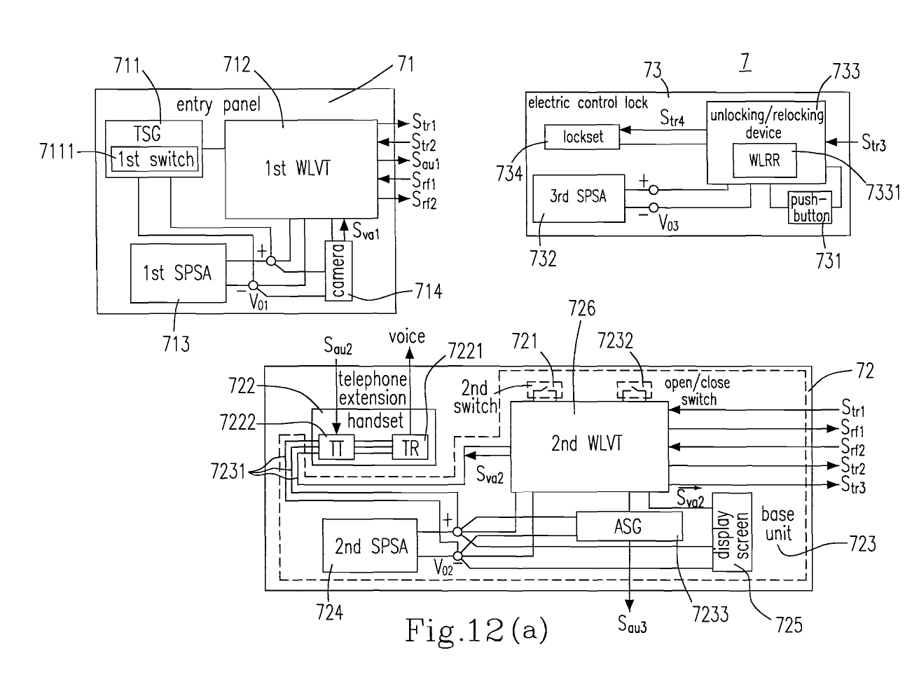

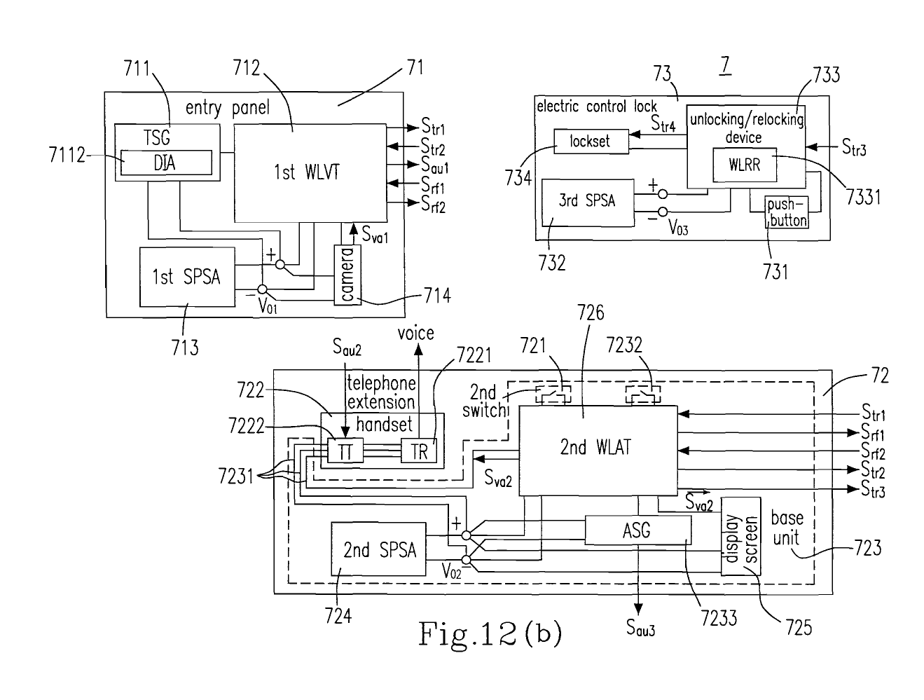

Please refer to FIG. 11(b), it shows the schematic circuit diagrams of a non-video door phone system 6 having three self-sustained power supply apparatuses according to the second preferred embodiment of the non-video door phone system of the present invention. The only difference between the second preferred embodiment and the first preferred embodiment of the non-video door phone system of the present invention as shown in FIG. 11(b) and FIG. 11(a) is that the plurality of first switches 6111 of the TSG 611 in FIG. 11(a) is replaced by a DIA 6112 in FIG. 11(b). In FIG. 12(a), it shows the schematic circuit diagrams of a video door phone system 7 having three self-sustained power supply apparatuses according to the first preferred embodiment of the video door phone system of the present invention. In FIG. 12(a), the video door phone system 7 includes an entry panel 71, a plurality of telephone extensions 72 and an electric control lock 73. In which, the entry panel 71 includes a TSG 711 having a first switch 7111, a first wireless video/audio transceiver (1^{st} WLVT) 712, a 1^{st} SPSA 713 and a camera 714. Each of the plurality of telephone extensions 72 includes a second switch 721, a handset 722 having a TR 7221 and a TT 7222, a base unit 723 having a telephone line 7231, a open/close switch 7232 and a ASG 7233, a 2^{nd} SPSA 724, a display screen 725 and a 2^{nd} WLVT 726. And the electric control lock 73 includes a push-button 731, a third SPSA 732, a unlock/relock device 733 having a WLRR 7331 and a lockset 734. The differences between the first preferred embodiment of the video door phone system 7 and the first preferred embodiment of the non-video door phone system 6 of the present invention as shown in FIG. 12(a) and FIG. 11(a) are that the 1^{st} WLAT and 2^{nd} WLAT in FIG. 11(a) are replaced by 1^{st} WLVT (coupled to an extra camera 714) and 2^{nd} WLVT (coupled to an extra display screen 725), the second audio signal Sau2 is replaced by a video/audio signal Sva1, the third audio signal Sau3 (a voice of a visitor) is replaced by a voice (also a voice of a visitor), the fourth audio signal Sau4 is replaced by the second audio signal Sau2, the fifth audio signal Sau5 is replaced by the third audio signal Sau3, and an extra second audio/video signal is added to the display screen 725 and the telephone line 6231 as shown in FIG. 12(a). The camera 714 is coupled to the 1^{st} SPSA 713. Also, the 1^{st} WLVT 712 turns on the camera 714 at the second status to generate the first video/audio signal, each of the plurality of telephone extensions further includes a display screen 725 coupled to the 2^{nd} SPSA 624 and the 2^{nd} WLAT, the Sva2 shows a video image on the display screen 725 and generates the voice (of the visitor), and the TR 7221 transmits the voice at the third status.

Please refer to FIG. 12(b), it shows the schematic circuit diagrams of a video door phone system 7 having three self-sustained power supply apparatuses according to the second preferred embodiment of the video door phone system of the present invention. The only difference between the second and the first preferred embodiments of the video door phone system 7 of the present invention is that the plurality of first switches 7111 of the TSG 711 in FIG. 12(a) is replaced by a DIA 7112 in FIG. 12(b).

From the above descriptions, the present invention provides a CCTV camera System to overcome the drawbacks of the prior art such that the installation location of the CCTV camera system is not limited by the location of the external power supply, there is no need of using the disposable and rechargeable batteries, and there is no waste battery generated so as to protect the global environment. Also, the present invention provides a wireless non-video and a wireless video door phone systems to overcome the drawbacks of the prior art such that the time-consuming set-up of the interconnect wiring and the trouble-shooting and the replacement of the damaged connecting wires during the maintenance for the conventional non-video/video door phone systems could be avoided totally.

Although the invention has been shown and described in terms of specific embodiments, it will be evident that changes and modifications are possible which do not in fact depart from the inventive concepts taught herein. It will be appreciated by those skilled in the art that various omissions, additions and modifications may be made to the processes described above without departing from the scope of the invention, and all such modifications and changes are intended to fall within the scope of the invention, as defined in appended claims.

What is claimed is:

1. A CCTV camera system having a self-sustained power supply apparatus for a video monitoring system having a main unit, comprising:
a camera receiving a first power supply from the apparatus and generating a video signal; and
a video transmission apparatus transmitting the video signal to the main unit.

2. A CCTV camera system according to claim 1, wherein the first power supply is one of a first AC power supply and a first DC power supply, and the self-sustained power supply apparatus comprises: an autogenic energy generating apparatus generating a second AC power supply;
a switch determining one of a turn-on and a turn-off states of the generating apparatus;
a rectifier rectifying the second AC power supply into a second DC power supply;
a regulator regulating the second DC power supply and generating a third DC power supply;
a DC/DC converter receiving the third DC power supply and generating the first DC power supply through one of a step-up and a step-down, wherein the DC/DC converter is one selected from a group consisting of a boost converter, a buck-boost converter and a flyback converter when the DC/DC converter is going through the step-up, and the DC/DC converter is one selected from a group consisting of a buck converter, a buck-boost converter, a forward converter, a flyback converter, a half-bridge converter and a full-bridge converter when the DC/DC converter is going through the step-down; and
a DC/AC inverter receiving the third DC power supply and generating the first AC power supply.

3. A CCTV camera system according to claim 1, wherein the first power supply is one of a first AC power supply and a first DC power supply, and the self-sustained power supply apparatus comprises:
an autogenic energy generating apparatus generating a second AC power supply;
a switch determining one of a turn-on and a turn-off states of the generating apparatus;
a rectifier rectifying the second AC power supply into a second DC power supply;
a regulator regulating the second DC power supply and generating a third DC power supply;
a DC/DC converter receiving the third DC power supply and generating the first DC power supply through one of a step-up and a step-down; and
a DC/AC inverter receiving the first DC power supply and generating the first AC power supply.

4. A CCTV camera system according to claim 1, wherein the first power supply is a first DC power supply, and the self-sustained power supply apparatus comprises:
an autogenic energy generating apparatus generating an AC power supply;
a switch determining one of a turn-on and a turn-off states of the generating apparatus;
a rectifier rectifying the AC power supply into a second DC power supply;
a regulator regulating the second DC power supply and generating a third DC power supply; and
a DC/DC converter receiving the third DC power supply and generating the first DC power supply through one of a step-up and a step-down.

5. A CCTV camera system according to claim 1, wherein the video transmission apparatus is one of a video signal line coupled to the video monitoring system and a wireless video transmission apparatus, the wireless video transmission apparatus comprises a radio transmitter and wirelessly transmits the video signal through one of a first and a second wireless transmission routes, in the first wireless transmission route, the wireless video transmission apparatus compresses the video signal and transmits the compressed video signal to a video receiving apparatus of the video monitoring system through a wireless local area network (LAN), and in the second wireless transmission route, the radio transmitter receives the video signal, transforms the video signal into a radio signal and transmits the radio signal to a radio receiver of the video monitoring system so as to display a video image on a video display apparatus, which is coupled to the radio receiver, of the video monitoring system.

6. A CCTV camera system according to claim 5, wherein the wireless video transmission apparatus receives the first power supply being one of a first AC and a first DC power supplies, and the self-sustained power supply apparatus comprises:
an autogenic energy generating apparatus generating a second AC power supply;
a switch determining one of a turn-on and a turn-off states of the generating apparatus;
a rectifier rectifying the second AC power supply into a second DC power supply;
a regulator regulating the second DC power supply and generating a third DC power supply;
a DC/DC converter receiving the third DC power supply and generating the first DC power supply through one of a step-up and a step-down; and
a DC/AC inverter receiving the third DC power supply and generating the first AC power supply.

7. A CCTV camera system according to claim 5, wherein the wireless video transmission apparatus receives the first power supply being a first DC power supply, and the self-sustained power supply apparatus comprises:
an autogenic energy generating apparatus generating an AC power supply;
a switch determining one of a turn-on and a turn-off states of the generating apparatus;
a rectifier rectifying the AC power supply into a second DC power supply;
a regulator regulating the second DC power supply and generating a third DC power supply; and
a DC/DC converter receiving the third DC power supply and generating the first DC power supply through one of a step-up and a step-down.

8. A CCTV camera system according to claim 5, wherein the first power supply is one selected from a group consisting of a first AC power supply, a first DC power supply and a second AC power supply, the camera receives one of the first AC power supply and the first DC power supply, the wireless video transmission apparatus receives the first power supply being one of the first DC power supply and the second AC power supply, and the self-sustained power supply apparatus comprises:
an autogenic energy generating apparatus generating a third AC power supply;
a switch determining one of a turn-on and a turn-off states of the generating apparatus;
a rectifier rectifying the third AC power supply into a second DC power supply;
a regulator regulating the second DC power supply and generating a third DC power supply;
a DC/DC converter receiving the third DC power supply and generating the first DC power supply through one of a step-up and a step-down;
a first DC/AC inverter receiving the third DC power supply and generating the first AC power supply; and
a second DC/AC inverter receiving the third DC power supply and generating the second AC power supply.

9. A CCTV camera system according to claim 5, wherein the first power supply is one selected from a group consisting of a first AC power supply, a first DC power supply and a second AC power supply, the camera receives one of the first AC power supply and the first DC power supply, the wireless video transmission apparatus receives the first power supply being one of the first DC power supply and the second AC power supply, and the self-sustained power supply apparatus comprises:
an autogenic energy generating apparatus generating a third AC power supply;
a switch determining one of a turn-on and a turn-off states of the generating apparatus;
a rectifier rectifying the third AC power supply into a second DC power supply;
a regulator regulating the second DC power supply and generating a third DC power supply;
a DC/DC converter receiving the third DC power supply and generating the first DC power supply through one of a step-up and a step-down;
a first DC/AC inverter receiving the first DC power supply and generating the first AC power supply; and
a second DC/AC inverter receiving the first DC power supply and generating the second AC power supply.

10. A CCTV camera system according to claim 5, wherein the first power supply is one selected from a group consisting of a first AC power supply, a first DC power supply and a second DC power supply, the camera receives one of the first AC power supply and the first DC power supply, the wireless video transmission apparatus receives the first power supply being one of the first AC power supply and the second DC power supply, and the self-sustained power supply apparatus comprises:
an autogenic energy generating apparatus generating a second AC power supply;
a switch determining one of a turn-on and a turn-off states of the generating apparatus;
a rectifier rectifying the second AC power supply into a third DC power supply;
a regulator regulating the third DC power supply and generating a fourth DC power supply;
a first DC/DC converter receiving the fourth DC power supply and generating the first DC power supply through one of a step-up and a step-down;
a DC/AC inverter receiving the fourth DC power supply and generating the first AC power supply; and
a second DC/DC converter receiving the fourth DC power supply and generating the second DC power supply through one of the step-up and the step-down, wherein one of the first and the second DC/DC converters, which is going through the step-up, is one selected from a group consisting of a boost converter, a buck-boost converter and a flyback converter, and one of the first and the second DC/DC converters, which is going through the step-down, is one selected from a group consisting of a buck converter, a buck-boost converter, a forward converter, a flyback converter, a half-bridge converter and a full-bridge converter.

11. A CCTV camera system according to claim 5, wherein the first power supply is one selected from a group consisting of a first AC power supply, a first DC power supply and a second DC power supply, the camera receives one of the first AC power supply and the first DC power supply, the wireless video transmission apparatus receives the first power supply being one of the first AC power supply and the second DC power supply, and the self-sustained power supply apparatus comprises:
an autogenic energy generating apparatus generating a second AC power supply;
a switch determining one of a turn-on and a turn-off states of the generating apparatus;
a rectifier rectifying the second AC power supply into a third DC power supply;
a regulator regulating the third DC power supply and generating a fourth DC power supply;
a first DC/DC converter receiving the fourth DC power supply and generating the first DC power supply through one of a step-up and a step-down;
a DC/AC inverter receiving one of the first and the second DC power supplies and generating the first AC power supply; and
a second DC/DC converter receiving the fourth DC power supply and generating the second DC power supply through one of the step-up and the step-down.

12. A CCTV camera system according to claim 5, wherein the first power supply is one of a first AC power supply and a first DC power supply, the wireless video transmission apparatus receives a second power supply being one of a second AC power supply and a second DC power supply, and the self-sustained power supply apparatus comprises:
an autogenic energy generating apparatus generating a third AC power supply;
a switch determining one of a turn-on and a turn-off states of the generating apparatus;
a rectifier rectifying the third AC power supply into a third DC power supply;
a regulator regulating the third DC power supply and generating a fourth DC power supply;
a first DC/DC converter receiving the fourth DC power supply and generating the first DC power supply through one of a step-up and a step-down;
a first DC/AC inverter receiving the fourth DC power supply and generating the first AC power supply;
a second DC/DC converter receiving the fourth DC power supply and generating the second DC power supply through one of the step-up and the step-down; and
a second DC/AC inverter receiving the fourth DC power supply and generating the second AC power supply.

13. A CCTV camera system according to claim 5, wherein the first power supply is one of a first AC power supply and a first DC power supply, the wireless video transmission apparatus receives a second power supply being one of a second AC power supply and a second DC power supply, and the self-sustained power supply apparatus comprises:
an autogenic energy generating apparatus generating a third AC power supply;
a switch determining one of a turn-on and a turn-off states of the generating apparatus;
a rectifier rectifying the third AC power supply into a third DC power supply;
a regulator regulating the third DC power supply and generating a fourth DC power supply;
a first DC/DC converter receiving the fourth DC power supply and generating the first DC power supply through one of a step-up and a step-down;
a first DC/AC inverter receiving the first DC power supply and generating the first AC power supply;
a second DC/DC converter receiving the fourth DC power supply and generating the second DC power supply through one of the step-up and the step-down; and
a second DC/AC inverter receiving the second DC power supply and generating the second AC power supply.

14. A CCTV camera system according to claim 5, wherein the wireless video transmission apparatus receives the first power supply being one of a first DC power supply and a second DC power supply, and the self-sustained power supply apparatus comprises:
an autogenic energy generating apparatus generating an AC power supply;
a switch determining one of a turn-on and a turn-off states of the generating apparatus;
a rectifier rectifying the AC power supply into a third DC power supply;
a regulator regulating the third DC power supply and generating a fourth DC power supply;
a first DC/DC converter receiving the fourth DC power supply and generating the first DC power supply through one of a step-up and a step-down; and
a second DC/DC converter receiving the fourth DC power supply and generating the second DC power supply through one of the step-up and the step-down.

15. A CCTV camera system according to claim 5, wherein the wireless video transmission apparatus receives the first power supply being one of a first DC power supply and a second DC power supply, and the self-sustained power supply apparatus comprises:
an autogenic energy generating apparatus generating an AC power supply;
a switch determining one of a turn-on and a turn-off states of the generating apparatus;
a rectifier rectifying the AC power supply into a third DC power supply;
a regulator regulating the third DC power supply and generating a fourth DC power supply;
a first DC/DC converter receiving the fourth DC power supply and generating the first DC power supply through one of a step-up and a step-down; and
a second DC/DC converter receiving the first DC power supply and generating the second DC power supply through one of the step-up and the step-down.

16. A CCTV camera system according to claim 5, wherein one selected from a group consisting of the wireless video transmission apparatus, the self-sustained power supply apparatus and a combination of the wireless video transmission apparatus and the self-sustained power supply apparatus is one of a built-in apparatus and a plug-in apparatus, the built-in apparatus is installed in a specific location inside the camera, and the plug-in apparatus comprises:
a case; and
a fixing device fixing the case at a surrounding location of the camera.

17. A CCTV camera system according to claim 1, wherein the camera is a CCTV camera, and the video monitoring system is a CCTV monitoring system.

18. A wireless door phone system, comprising:
an entry panel having a first wireless transceiver transmitting a first trigger signal at a first status of the system, and receiving a first radio frequency signal to generate a first audio signal at a second status of the system;
a plurality of telephone extensions, each of which transmits a second trigger signal at a third status of the system and transmits a third trigger signal at a fourth status of the system; and
an electric control lock having a push-button and generating a fourth trigger signal to unlock and relock in response to one of a situation that the third trigger signal is received by the electric control lock and the push-button is pushed down.

19. A door phone system according to claim 18, wherein the entry panel further comprises a trigger signal generator, the first status indicates that the generator is turned on, the second status indicates that the transceiver is turned on through receiving the second trigger signal and the transceiver further receives a first input signal so as to generate a second radio frequency signal, the entry panel further comprises a first self-sustained power supply apparatus generating a first power supply for the entry panel, the entry panel is installed at a main entrance of one of an apartment and a building, and the generator is coupled to the apparatus, and coupled to the transceiver, the generator is one of a plurality of first switches each having a push-button and a data input apparatus, the first status indicates a state being one of that the push-button of one of the plurality of first switches is pushed down and that a set of data correctly representing a room number and a floor number of one of the apartment and the building are input via the data input apparatus, and each of the plurality of telephone extensions further comprises:
a second switch having a push-button;
a second self-sustained power supply apparatus generating a second power supply for each of the plurality of telephone extensions;
a second wireless transceiver coupled to the second self-sustained power supply apparatus and the second switch, turned on to receive the second radio frequency signal so as to generate a first output signal at the third status and turned on to transmit the third trigger signal at the fourth status;
a handset having a telephone transmitter and a telephone receiver, wherein the telephone receiver is coupled to the second wireless transceiver, and transmits one of a voice and the first output signal at the third status, and the telephone transmitter is coupled to the second wireless transceiver, receives a second input signal, and generates the first radio frequency signal through the second wireless transceiver at the third status; and
a base unit having a telephone line coupled to the telephone transmitter and the second wireless transceiver, comprising:
an open/close switch coupled to the second wireless transceiver, wherein the open/close switch is turned on when the handset is off-hook such that the second wireless transceiver is turned on and sends out the second trigger signal to the entry panel at the third status, and the entry panel enters the second status after receiving the second trigger signal; and
an audio signal generator coupled to the second self-sustained power supply apparatus and the second wireless transceiver, wherein the audio signal generator sends out a second output signal and lasts for a first time period when the second wireless transceiver receives a specific first trigger signal at the first status,
wherein the push-button of the second switch is installed on the base unit, the handset is contained by the base unit when the handset is on-hook, and the second self-sustained power supply apparatus and the second wireless transceiver are installed in the base unit.

20. A door phone system according to claim 19, wherein the third status indicates that the handset is separate from the base unit, and the fourth status indicates that the push-button of the second switch is pushed down and the second switch is turned on.

21. A door phone system according to claim 19, wherein each one of those signals are transmitted and received by one of a radio wave and a combination of a radio wave and a wireless LAN.

22. A door phone system according to claim 19, wherein the door phone system is one of a non-video door phone system and a video door phone system, the first wireless transceiver is a first wireless audio transceiver, the second wireless transceiver is a second wireless audio transceiver, the first input signal is a second audio signal, the first output signal is a third audio signal, the second input signal is a fourth audio signal, the second output signal is a fifth audio signal, and the telephone receiver transmits the third audio signal at the third status when the door phone system is the non-video door phone system.

23. A door phone system according to claim 19, wherein the door phone system is one of a non-video door phone system and a video door phone system, the first wireless transceiver is a first wireless video/audio transceiver, the second wireless transceiver is a second wireless video/audio transceiver, the first input signal is a first video/audio signal, the first output signal is a second video/audio signal, the second input signal is a second audio signal, the second output signal is a third audio signal, the entry panel further comprises a camera coupled to the first self-sustained power supply apparatus and the first wireless video/audio transceiver, the first wireless video/audio transceiver turns on the camera at the second status to generate the first video/audio signal, each of the plurality of telephone extensions further comprises a display screen coupled to the second self-sustained power supply apparatus and the second wireless video/audio transceiver, the second video/audio signal shows a video image on the display screen and generates the voice, and the telephone receiver transmits the voice at the third status when the door phone system is the video door phone system.

24. A door phone system according to claim 19, wherein the electric control lock further comprises:
a lockset;
a third self-sustained power supply apparatus generating a third power supply for the electric control lock; and
an unlocking/relocking device having a wireless radio receiver, receiving the third trigger signal and coupled to the third self-sustained power supply apparatus,
wherein the electric control lock is installed on a main entry door of one of the apartment and the building, the unlocking/relocking device is employed to generate the fourth trigger signal to unlock the lockset, an unlocking status of the electric control lock lasts for a second time period, and the electric control lock relocks when a period of the second time period is past.

25. A door phone system according to claim 24, wherein each of the first, the second and the third power supplies is a first DC power supply, each of the first, the second and the third self-sustained power supply apparatuses comprises:
an autogenic energy generating apparatus generating an AC power supply;
a switch determining one of a turn-on and a turn-off states of the generating apparatus;
a rectifier rectifying the AC power supply into a second DC power supply;
a regulator regulating the second DC power supply and generating a third DC power supply; and
a DC/DC converter receiving the third DC power supply and generating the first DC power supply through one of a step-up and a step-down.

26. A door phone system according to claim 24, wherein each of the first, the second and the third power supplies is one of a first AC power supply and a first DC power supply when the door phone system is the video door phone system, each of the first, the second and the third self-sustained power supply apparatuses comprises:
an autogenic energy generating apparatus generating a second AC power supply;
a third switch determining one of a turn-on and a turn-off states of the generating apparatus;
a rectifier rectifying the second AC power supply into a second DC power supply;
a regulator regulating the second DC power supply and generating a third DC power supply; and
a DC/DC converter receiving the third DC power supply and generating the first DC power supply through one of a step-up and a step-down; and
a DC/AC inverter receiving the third DC power supply and generating the first AC power supply.

27. A wireless door phone system having a first, a second and a third self-sustained power supply apparatuses, comprising:
an entry panel having a first wireless transceiver and coupled to the first self-sustained power supply apparatus, wherein the transceiver transmits a first trigger signal at a first status, and receives a first radio frequency signal to generate a first audio signal at a second status;
a plurality of telephone extensions coupled to the second self-sustained power supply apparatus, wherein each of the plurality of telephone extensions transmits a second trigger signal at a third status and transmits a third trigger signal at a fourth status; and
an electric control lock having a push-button and coupled to the third self-sustained power supply apparatus, wherein the electric control lock generates a fourth trigger signal to unlock and relock when one of the third trigger signal is received by the electric control lock and the push-button is pushed down.

28. A door phone system according to claim 27, wherein the door phone system is one of a non-video door phone system and a video door phone system, the first wireless transceiver is a first wireless audio transceiver when the door phone system is the non-video door phone system, and the first wireless transceiver is a first wireless video/audio transceiver when the door phone system is the video door phone system.
